(19) United States
(12) Patent Application Publication
(10) Pub. No.: US 2023/0149896 A1
(43) Pub. Date: May 18, 2023

(54) SYSTEMS AND METHODS FOR CARBON DIOXIDE CAPTURE

(71) Applicants: Peter EISENBERGER, Princeton, NJ (US); Eric W. PING, Thornton, CO (US); Miles SAKWA-NOVAK, Atlanta, GA (US)

(72) Inventors: Peter EISENBERGER, Princeton, NJ (US); Eric W. PING, Thornton, CO (US); Miles SAKWA-NOVAK, Atlanta, GA (US)

(21) Appl. No.: 17/912,798

(22) PCT Filed: Mar. 22, 2022
(86) PCT No.: PCT/US2021/023473

§ 371 Date: Sep. 19, 2022

Related U.S. Application Data
(60) Provisional application No. 62/992,782, filed on Mar. 20, 2020.
(60) Provisional application No. 62/705,061, filed on Jun. 9, 2020.
(60) Provisional application No. 63/198,418, filed on Oct. 16, 2020.

(51) Int. Cl. B01J 20/26; B01J 20/28; B01J 20/08; B01J 20/34; B01D 53/62; B01D 53/96

(52) U.S. Cl. CPC B01J 20/262; B01J 20/28045; B01J 20/28092; B01J 20/28085; B01J 20/28083; B01J 20/08; B01J 20/3483; B01J 20/3425; B01D 53/62; B01D 53/96; B01D 2257/504; B01D 2258/0283

(57) ABSTRACT

There is provided a structurally stable monolith substrate, suitable to provide carbon dioxide capture structure for removing carbon dioxide from air, having two major opposed surfaces, and further having a plurality of longitudinal channels extending between and opening through the two major opposed surfaces of the structurally stable monolith substrate; and a macroporous coating, adhered to the interior wall surfaces of the longitudinal channels, comprising an adherent, coating formed of cohered, compact mesoporous particles each being formed of a material that is compatible with the material forming the underlying substrate structure so as to become adherent thereto when coated. The mesoporous particles are capable of supporting in their mesopores a sorbent for CO₂ There is also provided a method for forming the monolith and a system for utilizing the monolith as part of a CO₂ capture structure, within the system, to remove CO₂ from the atmosphere.

### INTRODUCTION AND BACKGROUND OF THE INVENTION

The prior art teach us that there may be myriad methods products, apparatus and systems capable of capturing and sequestering carbon dioxide, and other acidic gases from mixtures of gases. However, the art has not as yet found a product that can be used in different systems and apparatus in a highly effective and efficient manner, both from the view of capital and operating costs and from the view of energy efficiency. The following patents disclose some of the apparatus and systems in which the product of the present invention can be used.

There is much attention currently focused upon trying to achieve three somewhat conflicting energy related objectives: 1) provide affordable energy for economic development; 2) achieve energy security; and 3) avoid the destructive climate change caused by global warming. However, it is believed by experts in the energy field that it is unlikely that our society will be able to avoid using fossil fuels at least during a significant part of this century.

It is also clear that there is a continuing need for further improvement in the efficiency of the systems and methods for removing additional CO2 from the atmosphere, known as Direct Air Capture (or DAC). All of the following patents and patent applications are directed and relate to the capture of carbon dioxide from ambient air and mixtures of gases, some of which contain ambient air.
U.S. Pat. No. 10,512,880 granted Dec. 24, 2019 entitled “Rotating multi-monolith capture structure movement system for removing carbon dioxide from the atmosphere.”
U.S. Pat. No. 10,413,866 granted Sep. 17, 2019 entitled “System and method for carbon dioxide capture and sequestration.”
U.S. Pat. No. 10,239,017 granted Mar. 26, 2019 entitled “System and method for carbon dioxide capture and sequestration.”
U.S. Pat. No. 9,975,087 granted Mary 22, 2018 entitled “System and method for carbon dioxide capture and sequestration from relatively high concentration carbon dioxide mixtures.”
U.S. Pat. No. 9,937,461 granted Apr. 10, 2018 entitled “System and method for carbon dioxide capture and sequestration utilizing an improved substrate structure.”
U.S. Pat. No. 9,925,488 granted Mar. 27, 2018 entitled “Rotating multi-monolith capture structure movement system for removing carbon dioxide from the atmosphere.”
U.S. Pat. No. 9,908,080 granted Mar. 6, 2018 entitled “System and method for removing carbon dioxide from an atmosphere and global thermostat using the same.”
U.S. Pat. No. 9,878,286 granted Jan. 30, 2018 entitled “System and method for carbon dioxide capture and sequestration.”
U.S. Pat. No. 9,776,131 granted Oct. 3, 2017 entitled “System and method for carbon dioxide capture and sequestration.”
U.S. Pat. No. 9,630,143 granted Apr. 25, 2017 entitled “System and method for carbon dioxide capture and sequestration utilizing an improved substrate structure.”
U.S. Pat. No. 9,616,378 granted Apr. 11, 2017 entitled “System and method for carbon dioxide capture and sequestration from relatively high concentration carbon dioxide mixtures.”
U.S. Pat. No. 9,555,365 granted Jan. 31, 2017 entitled “System and method for removing carbon dioxide from an atmosphere and global thermostat using same.”
U.S. Pat. No. 9,433,896 granted Sep. 6, 2016 entitled “System and method for carbon dioxide capture and sequestration.”
U.S. Pat. No. 9,227,153 granted Jan. 5, 2016 entitled “Carbon dioxide capture/regeneration method using monolith.”
U.S. Pat. No. 9,061,237 granted Jun. 23, 2015 entitled “System and method for removing carbon dioxide from an atmosphere and global thermostat using same.”
U.S. Pat. No. 9,028,592 granted May 12, 2015 entitled “System and method for carbon dioxide capture and sequestration from relatively high concentration carbon dioxide mixtures.”
U.S. Pat. No. 8,894,747 granted Nov. 25, 2014 entitled “System and method for removing carbon dioxide from an atmosphere and global thermostat using the same.”
U.S. Pat. No. 8,696,801 granted Apr. 15, 2014 entitled “Carbon dioxide capture/regeneration apparatus.”
U.S. Pat. No. 8,500,861 granted Aug. 6, 2013 entitled “Carbon dioxide capture/regeneration method using co-generation.”
U.S. Pat. No. 8,500,860 granted Aug. 6, 2013 entitled “Carbon dioxide capture/regeneration method using effluent gas.”
U.S. Pat. No. 8,500,859 granted Aug. 6, 2013 entitled “Carbon dioxide capture/regeneration method using vertical elevator and storage.”
U.S. Pat. No. 8,500,858 granted Aug. 6, 2013 entitled “Carbon dioxide capture/regeneration method using vertical elevator.”
U.S. Pat. No. 8,500,857 granted Aug. 6, 2013 entitled “Carbon dioxide capture/regeneration method using gas mixture.”
U.S. Pat. No. 8,500,855 granted Aug. 6, 2013 entitled “System and method for carbon dioxide capture and sequestration.”
U.S. Pat. No. 8,491,705 granted Jul. 23, 2013 entitled “Application of amine-tethered solid sorbents for carbon dioxide fixation from air.”
U.S. Pat. No. 8,163,066 granted Apr. 24, 2012 entitled “Carbon dioxide capture/regeneration structures and techniques.”

The present invention provides a monolith product that will be useful in improving the operation of the above and many other products and systems previously used for the removal of CO2 from the atmosphere.

### GENERAL STATEMENT OF THIS INVENTION

The present invention teaches a novel and surprisingly effective product, that can be associated and combined with many systems, apparatus and methods of capturing carbon dioxide or other acidic gases, from ambient air or from mixtures of other gases mixed with ambient air, mixtures such as ambient air with a minor proportion of an effluent gas, or flue gas, from processes powered by, e.g., the oxidation of hydrocarbons. In one embodiment of the present invention disclosed herein, carbon dioxide is captured using a system comprising a rotating multi-capture movement system, described in more detail below. In another embodiment of the invention, carbon dioxide is removed from a stream of gas that includes ambient air, combined with flue gas from a fossil fuel combustion source. In yet another system in which the present invention of a defined product is used for removing CO2 from mixed gases; the product of this invention is supported within a stationary system, which alternates as the CO2 separation chamber and the regeneration chamber; this stationary system is operated by the automated opening and closing of valves controlling flow through conduits into or out from the stationary chamber, and out from or into sources of the desired gas or vapor or destinations for the outputs from the system, as well as for other fluids for treating the feed gases or for regenerating the sorption systems.

Additionally, and in one embodiment, the present invention teaches the combination of a structural, rigid, substrate, defined further as having longitudinal channels extending between opposing surfaces of the substrate, the channels have walls that support, within the longitudinal channels, an applied dried and sintered coating of defined predetermined characteristics. In one preferred embodiment of the present invention, the rigid substrate is formed in the general shape of a solid form having a generally polyhedral shape, or a tubular shape. In more preferred embodiments, for space efficiency reasons under most circumstances, in the shapes of regular polyhedrons. In all geometrical shape embodiments, the rigid substrates are formed with longitudinal channels extending therethrough, the channels having outer surfaces through which the gas mixture to be treated flows. The walls of the channels are coated with a solid macro-mesoporous coating formed of sintered coherent mesoporous particles adhered to the wall of the channel, leaving a central channel for passage of the ambient air or the mixed gases.

One method for forming the macro-mesoporous coating is to apply a liquid slurry comprising mesoporous particles, binders and rheologically effective materials, to form a viscous slurry that adheres to the walls of the channels in the substrate, so that the slurry can be dried and sintered to the walls of the channels. The sintered adhered coating has characteristics that can be defined as a sintered, coherent, mass of porous particles, providing a combination of macropores and mesopores, both of defined sizes.

In one embodiment the macropores are provided by the spacing between the individual sintered particles forming the coating and the mesopores are formed as pores within each particle. In preferred embodiments, the macropore separation of the particles is preferably at least about 200 nm, and in another embodiment the separation is between 200 and 500 nanometers. In other preferred embodiments, the mesopores within each particle have pore diameters of at least about 10 nm and in another preferred embodiment a pore size of preferably between 20 and 50 nm in diameter.

The aforementioned channel wall coatings, in another embodiment, can be formed from a liquid slurry of particles suspended in a liquid, and where particles have a diameter of at least about 200 nm and preferably a particle diameter of between 200 and 900 nm. It is contemplated by the present invention that the said slurry, when applied on the surface of the channels through a stable solid substrate and then sintered, the particles cohere together and adhere to the stable substrate channel walls. In one embodiment, the individual mesoporous particle diameter can be substantially the same size as the macropore diameter, especially when the particles are compact in shape, and are sintered together. The macropores can be slightly larger than the original compact particle size. The actual predetermined macropore size is a function of the particle size, the distribution of particle sizes, and the other materials present in the slurry, as well as the sintering process. The individual particles making up the slurry are formed such that they have internal porosity in the range of the desired mesoporosity of the finished sintered washcoat. In preferred embodiments, the overall diameters of the coating particles have a particle size that varies by not more than about 20% and more preferably of not greater than 10%.

It is further contemplated by this invention that, in order to achieve a desired predetermined macropore size throughout the sintered washcoat, the individual particles are relatively compact in substantially all directions.

In another embodiment, the aforementioned individual particles are preferably formed of a metal oxide, such as alumina or titania, although other such metal oxides are contemplated as coming within the scope of the present invention.

The slurried washcoat can be applied as a single coating or in multiple coats. When sintering the slurry coated upon the channel walls of the structurally stable substrate, the preferred sintering temperature of the sintering temperature will be a function of the material of the particle, as well as the materials forming the liquid suspension and the material forming the structural substrate; such a temperature, in one embodiment of the preparation is as low as 250° F. The slurrying liquid is preferably an aqueous liquid containing a desired binder material, such as boehmite, to assist in forming the desired sintered structure.

### DISCUSSION

It is now clear that there are many technically feasible methods available to directly capture carbon dioxide from the atmosphere utilizing, e.g., a single capture large monolithic unit operating together with a regeneration system, whereby the CO2 is directly adsorbed onto the monolith, as described above. These systems, as well as others to be developed in the future can be greatly improved by using the channel containing monoliths of the present invention, which contain a plurality of separate sorbent supporting particle-coated channels extending therethrough. In one embodiment a large monolithic unit can be formed of a plurality of smaller monoliths formed in accordance with the present invention, by combining and holding together, either by adhesively binding a plurality of small monoliths together or by binding them together by an outside framework within which the individual small monoliths are held together.

A preferred embodiment can be formed of a plurality of smaller modular tubular monoliths, stacked together, or by forming a single large monolith. In all cases, it is necessary to provide channels extending through each portion of the monolith or through each of the modular smaller monoliths. The total size of the individual capture structures, which can be formed of a plurality of any number of smaller modules having the individual channels extending therethrough. The individual modules can be adhesively bound together, and/or held together within an outer frame. The individual modular monoliths can have, for example only, cross-sections of polygons, such as polygons such as squares, hexagons, octagons, or rounded shapes such as circular or ovoidal.

Each monolith or modular small monolith is provided with longitudinal channels extending between the opposing sides of the monolith or modular small monolith, and can have substantially any cross-sectional shape, including, by way of example only, polygons such as triangular, or parallelograms, including without limitation, squares, rectangles, hexagons, or octagons, or rounded shapes such as circular or ovoidal.

The critical portion of each capture structure is the density of the channels extending through the single monolith or bound individual modular monolithic capture structure. Preferably the channels are substantially parallel in the entire structure. The channels can have cross-sections that are of almost any configuration, as long as the flow of air is not overly constricted. Exemplary channel cross-sections include triangular, or parallelograms, including without limitation, squares, rectangles, hexagons, or octagons, or rounded shapes such as circular or ovoidal, bell-curves (think corrugated cardboard), diamonds/rhomboids.

In one preferred embodiment of this invention the total capture structure monolith can be formed of a plurality tubular modules having one of the above cross-sectional shapes.

In one embodiment, the monolith is moved between a location where it is exposed to the ambient air, or to mixture of gases, and then moved to a separate regeneration unit; in another embodiment the monolith is maintained within the same chamber and by the use of automatically operating valved conduits the same chamber can be used for passing the CO2-rich gas mixture through the channels of the monolith and for regeneration of the sorbent held within the mesopores of the particles coated on the channel walls in the monolith, to release the CO2 and to regenerate the sorbent for future use.

In both embodiments, the sorbent-supporting monolith is treated with process heat preferably in the form of steam generated from the secondary energy output of some type of a primary system, such as a power generating unit, a cement plant, or other manufacturing facility. In each of these cases the mesoporous substrate structure for the sorbent will contain sufficient sorbent to permit the economical removal of carbon dioxide from air and produce substantially pure CO2 during regeneration; the substantially pure CO2 can be available, for example, for the manufacture of hydrocarbon fuels, or available for improving the agricultural output of greenhouses or other applications requiring merchant CO2.

These and other features of this invention are described in, or are apparent from, the following more detailed description, related to the accompanying drawings.

### BRIEF DESCRIPTION OF THE FIGURES/EXHIBITS

FIG. 1 is a diagrammatic top view of one preferred embodiment of this invention showing a mutually interactive pair of rotating multi-capture structure systems for removing carbon dioxide from the atmosphere according to an exemplary embodiment of this invention, illustrating in sketch form a grade level regeneration chamber for each loop and a plurality of capture structures, the two capture structures immediately upstream from each of the regeneration chambers being provided with sealable conduits for feeding cleaned flue gas to the capture structures;

FIG. 2 is a schematic illustration of a track level version of a pair of regenerating chambers for removing carbon dioxide from the capture structures medium of FIG. 1, showing the movement of the capture structures along the track level, air or flue gas contact positions (where the gas flow can be aided by a mechanical blower) into the regeneration chamber position;

FIG. 3 is a top plan [schematic elevation] view of the regeneration chambers of FIG. 2, and capture structures on adjacent capture structures, showing the piping system arrangement for each chamber and between the chambers;

FIG. 4 is a schematic elevation view showing fans which are stationary relative to one of the capture structures, and which rotate with its respective capture structure;

FIG. 5 is a diagrammatic side elevation view of a design for Dual Induced Axial Fans and Plenums of FIG. 4;

FIG. 6 is a diagrammatic representation of an all-around seal between a regeneration box and monolith structure;

FIG. 7 is a diagrammatic elevation view of one of the mutually interactive pair of rotating multi-capture structures system, showing the track level regeneration chamber for removing carbon dioxide from the atmosphere, and the immediately successive capture structure treating a flue gas for CO2 capture;

FIG. 8 is a block diagram depicting the basic concept of direct air capture from ambient air where the adsorption unit is exposed to ambient air for a predetermined period of time, that is 9 times longer in duration than the time each unit spends in the desorption or regeneration unit; The monolith product of the present invention improves the effectiveness of a system such as this compared to prior such sorbent-supporting structures;

FIG. 9 is a block diagram of the improved CO2 capture system of the present invention wherein ambient air is passed over the direct air adsorption unit for a period of time 8 times longer than each unit spends in the CO2 desorption unit and in the final, ninth stage, before desorption the ambient air is admixed with flue gas to form a gas mixture containing about 1% CO2 in the final stage before being placed in the CO2 desorption or regeneration unit; The monolith product of the present invention improves the effectiveness of a system such as this compared to prior such sorbent-supporting structures;

FIG. 9A is a further variation of the direct air capture unit wherein the exhaust from the 9^{th} stage is passed back to be mixed with the ambient air in the 8^{th} stage before the 8^{th} stage passes into the 9^{th} stage where it is blended with the mixture of fresh flue gas and air to form a feed of 1% CO2;

FIG. 10 depicts an idealized drawing of the sintered macro-mesoporous coating of the walls of the longitudinal channels through the monolithic carrier of the present invention, in a situation where the size of the compact individual sintered particles are fairly uniform;

10A depicts a diagrammatic comparison showing the effect of a greater distribution of different sized particles on the macropore size openings existing between the particles of the sintered particulate porous coating;

10B depicts the internal mesopores extending into the individual particles of the sintered coating;

FIG. 11 is a cross-sectional diagram depicting an individual longitudinal channel through each monolith, showing the channel wall 760, the sintered washcoat for supporting the CO2-sorbent 763, and the open longitudinal channel through the monolith for the passage of the CO2-rich gases;

FIG. 11A depicts three sizes of the basic monoliths 760, and the protective and in some cases supporting screen connected to the opposing faces between which the longitudinal channels extend;

FIG. 11B depicts in diagrammatic form the flow of the ambient air through the monolith longitudinal channels 765, with the CO2 molecules being absorbed by the sorbent supported in the sintered coating and aa partial cross-section showing the channels and the walls between the channels extending between opposing sides of a monolith in cubic form;

FIG. 11C depicts a cordierite monolith, containing 230 longitudinal channels per square inch (“CPSI”), with 8 mil walls between the channels, providing 77.2% OFA;

FIG. 11D depicts a cordierite monolith, containing 230 longitudinal channels CPSI, with 7.5 mil walls between the channels, providing 77.2% OFA;

FIG. 11E depicts an aluminum hex cell monolith, containing 100 longitudinal channels CPSI, with 1.2 mil walls between the channels, providing 97.6% OFA;

FIG. 11F depicts an alumina-fiberglass corrugated cell monolith, containing 70 longitudinal channels CPSI, with 13 mil walls between the channels, providing 79% OFA;

FIG. 11G depicts a porous titania extrudate monolith, containing 170 longitudinal channels CPSI, with 9 mil walls between the channels, providing 77.9% OFA;

FIG. 12 shows the change in efficiency with increased loading of the sorbent based upon percent of amine sorbent loading in the mesopores of the sintered coating on the channel walls;

FIG. 13 shows the change in amine efficiency with increased loading ratio of the sorbent based upon percent of amine sorbent loading in the mesopores of the sintered SiO2 coating on the channel walls;

FIG. 14 shows the effect of particle size on the diffusion of the CO2 from the surface of the monolith wall to the particle holding the sorbent;

FIGS. 15-18 depict the graphical results of the Examples 1-4 in the specification.

### DETAILED DESCRIPTION OF THE INVENTION

In an embodiment of this invention, the sintered coating is from a viscous slurry comprising mesoporous particles and ancillary materials, such as binders and rheological materials that provide sufficient viscosity and adhesion to adhere in an even coating on the channels of the solid monolith.

In another embodiment of the present invention, the capture structures for exposure to the flow of CO2-rich gases a single structure formed from a plurality of the individual small monoliths secured together by an adhesive or an outer framework pressing the individual small monoliths together, to form a single large monolith providing the desired open longitudinal channels to the flow of CO2-rich gases to be cleaned of CO2. Preferably all of the small monoliths joined together have the same CPSI and the same amount of sorbent in the channel wall coating.

The monoliths can be exposed to the mixed gases while moving and moved into a separate regeneration chamber for regenerating the sorbent by stripping the sorbed CO2 from the coated walls on the channel walls of the monolith.

In another embodiment, the monolith with the coated longitudinal channel walls can be immovable while exposed to the CO2-rich gases and then a sealable chamber can be moved around the monolith, within which it can be regenerated to strip and capture the CO2 sorbed on the walls coated with the sorbent-supporting coating.

In yet another embodiment of this invention, the monolith can be maintained within a single sealable chamber and alternatively exposed to the CO2-rich gases and then the process heat steam for stripping the CO2, and regenerating the sorbent, by the automatic operation of valving to change the materials entering and leaving the chamber. Specifically, the automatic operation of the valved conduits connected to the closed and sealed structure, are designed by known methods to be capable of switching between a source of ambient air, i.e., the atmosphere, for example, and a source of process heat steam, for example. Steam sourced from preferably the secondary process heat of a primary plant, can be used in these carbon capture systems at temperatures of not greater than 120° Celsius and preferably below 100° C., to as low as 60° C., so that the operating costs for the system would be lowered.

In yet another embodiment of the present invention, a non-coated monolith, such as, by way of example only, a fully porous monolith provided with the longitudinal channels where the walls are formed of the sintered mesoporous particles and the space between particles provide the necessary macroporous openings. In this embodiment, porous titania extrusions are useful, as well as porous alumina or porous silica or other porous metal oxides.

In one embodiment, the use of a fully porous extrusion, formed as individual bricks, provide a useful construction for a desired non-coated monolith comprising a stack of monolithic bricks having the desired structural durability and rigidity, preferably having a porous surface and narrow channels extending longitudinally through each brick, that will provide the necessary volume for the required reservoir of the desired sorbent. In this situation adsorbency is by the amount of sorbent present in the pores on the surface of the walls of the longitudinal channels through each brick.

In all of the embodiments of this invention, the amount of porosity, i.e., the macroporosity and the mesoporosity, required is a function of the time period required for the sorbent action to be accomplished for a given amount of sorbent material. This allows for the greatest economy of scale when adsorbing CO2 using a sorbent-containing porous substrate. In one embodiment, relatively small bricks, in a hexahedral shape, such as one where all of the surfaces are squares or one in which the four largest faces are rectangular, are piled into a tetrahedral shape where the two largest faces are rectangular, and the piled shape is supported by a surrounding frame to provide the necessary structural strength of the overall monolithic structure. Alternatively, or in addition, the individual brick monoliths, may be adhesively connected. In some embodiments, this large monolithic structure formed of the piled bricks comprises the capture structures in the system and methods for air capture, described herein.

In the preferred embodiment, the structural substrate is formed so as to include straight longitudinal channels running axially between the two exposed major surfaces. In the more common case, the walls of the channels are coated with a sintered coating having a thickness of at least 2 mils. The coating is preferably formed of compact mesoporous particles having a diameter of at least about 200 nm.

The internal structural substrate can be formed of a structurally strong Cordierite, aluminum, fiberglass, fecralloy, other metals, inorganic oxides (alumina, titania, silica, etc.), ceramic, polymers (polyethylene, polypropylene, polycarbonate, etc.), carbon, etc. Some of these materials should be used under certain circumstances, where the temperatures are maintained at a lower value, such as fiberglass impregnated polymers, other plastics and carbon fiber enhanced such materials.

All of these structural substrates can be manufactured by extrusion, aggregation, corrugating, templating, 3D printing, molding, etc. The structural substrate is to provide structurally stable geometry, at the operating temperatures for the sorbent apparatus as it is exposed to ambient air or mixtures of ambient air with an effluent gas such as that sourced from a hydrocarbon fuel heating system, or while the sorbent is being regenerated. The structural substrate must be capable of stably supporting a cell density and channel shape, for the combination with a porous coating. The porous coating must be formed of porous particles that can be sintered together to form what will be referred to as the macroporous coating structure supported on the channel walls of the structural substrate. It must form a stable porous coating having good physical and chemical adhesion with the structural substrate in order to form the desired mesoporous structure within which the sorbent will be primarily maintained.
a. The monolith structural substrate with straight channels running axially, can be formed of Cordierite, aluminum, fiberglass, fecralloy, other metals, inorganic oxides (alumina, titania, silica, etc.), ceramic, polymers (polyethylene, polypropylene, polycarbonate, etc.), carbon, etc. The substrate can be formed by being extruded, corrugated, templated, 3D printed, molded, etc. to form the monolith structure. The material forming the substrate can be porous or nonporous. The cell density (channel openings), in preferred embodiments of this invention can be 50-400 CPSI. The channel wall thickness, in preferred embodiments of this invention, can be 0.2 mil-20 mil. The OFA of the faces into which the channels open, in preferred embodiments of this invention can be 0.5-0.98th. The channel cross section geometry, in preferred exemplary embodiments of this invention, can be polygons such as squares, hexagons, octagons, or circular or ovoidal, bell-curves (think corrugated cardboard), diamonds/rhomboids. The individual channels can have a length of, in preferred embodiments of this invention, 3-24″. The channels, in preferred embodiments of this invention, can be coated with a macro-mesoporous coating, via dipcoating (single or sequential) or some other coating method with a washcoat slurry containing mesoporous particles applied to a substrate channel walls as defined above, to form a macro-mesoporous coating. The coating comprises mesoporous particles of inorganic oxide (alumina, silica, titania, etc.), porous mineral/ceramic (e.g., boehmite), etc. The porosity is in the range 0.7-0.96, in preferred embodiments of this invention, and have a mesopore volume range of 0.4 cc/g-1.5 cc/g. The most prevalent mesopore diameter is 10-50 nm, with a coating thickness range of 2-15 mil after sintering. The macropore diameter range, in preferred embodiments of this invention, is 0.1-2 microns; and the macropore/mesopore ratio range is 1:5-2:1 (20% macro-80% meso to 66% macro-33% meso).

The porous coatings on the channel walls can accept, in preferred embodiments of this invention, an active sorbent material, preferentially in the mesopores. The sorbent can be physically impregnated or chemically bonded to the mesoporous particles and can be aminopolymers (pei, ppi, paa, pva, pgam, etc), blends of polymers (aminopolymers with each other, aminopolymers with PEGs, etc.), chemically modified polymers, polymers+ additive blends, MOFs, zeolites, etc.

The polymers can be branched, linear, hyperbranched, or dendritic, and a molecular weight range of 500-25000 Da, depending upon the polymer structure. Mesopore volume occupancy of the sorbent (pore filling), in preferred embodiments of this invention, can range from 40-100%. The macropore volume occupancy (pore filling) range can be 0-15%.

In another preferred embodiment of this invention, the entire monolith substrate with longitudinal channels, is formed of the macro-mesoporous media described as a coating above. In other words, the entire monolith is a homogeneous porous body, having no distinct interface between substrate and channel wall washcoat, but containing meso-macroporous particles throughout the monolith. One example of such a homogeneous porous body, includes homogeneous porous monolith formed of a fibrous network, the fibers providing the body structural integrity and the adhered particles providing the entire body with meso and macroporosity:

The material forming the embedded particles can include, in some embodiments, the same inorganic oxides (alumina, titania, silica, etc.), ceramic, carbon, polymer, binders and fillers.

The cell density of the channel openings are preferably in the range of 64-400 cpsi. The channel wall thickness is preferably 3-30 mil, with an OFA of 0.5-0.8; and the channel opening cross section geometry in some of these embodiments can be, for example, square, hexagonal, cylindrical, bell-curve (as in corrugated cardboard), diamond/rhomboid, etc.; other preferred parameters of these homogeneous monoliths are:
Channel length of 3-24″;
Porosity range of 0.3-0.9
Mesopore volume range of 0.2 cc/g-1.5 cc/g
The preferred range of most prevalent mesopore diameter is in the range of 10-50 nm;
The preferred macropore diameter range is 0.15-2 micron; and
Macropore/mesopore ratio range is 1:5-3:1 (20% macro-80% meso to 75% macro-25% meso)
Cell, or channel opening density of 64-400 cpsi;
wall thickness, between the channel openings of 3-30 mil;
an OFA of 0.5-0.8

As previously explained, the particles on the walls of the channels can accept the same active sorbent materials as described above for the coated wall structures.

A system for that purpose of capturing CO2 has been developed that includes the above structures and a method for achieving the efficient and effective capture of CO2 from ambient air and other mixtures of gases.

In most embodiments of this invention, except as described immediately above, the structural substrate is substantially inert with regard to sorbent activity or to the slurried washcoat, so that the mass of the substrate monolith should be minimized by forming the channel walls at a minimum thickness sufficient to maintain its structural strength and stable structure. In one preferred embodiment, the substrate will be provided with straight channels connecting two opposed surfaces of the monolith. The wall thickness separating the longitudinal channels should be preferably from 0.2 mil-20 mil, as long as it is sufficient to maintain structural integrity. This effectively minimizes the thermal mass of the monolith structure, and thus minimize the costs of the heating or cooling required during adsorption or desorption, while maintaining sufficient structural strength to maintain the shape of the porous walls, which maintains the structure of the macropores to permit the mixed gas to reach the sorbent in the mesopores of the particles. Maintaining the shape of the channel walls also prevents the collapsing of the channels, so as to maintain the flow of the gas without requiring increasing pressure drop. Pressure drop is a function of the hydraulic diameter and lengths of the open channels through the structural substrate. The channel openings density is preferably in the range of 50-400 CPSI.

In another preferred embodiment, the commercial monolith will be formed of individual bricks stacked together in a stable geometry, where the individual bricks are as described above, preferably, e.g., polyhedrons such as hexahedrons or decahedrons, or tubular shapes, in all cases having longitudinal channels extending between opposing faces, with the interior walls separating the channels being coated with the macro-mesoporous coating; the length of each individual brick is preferably in the range of 3-24 ins.; the individual bricks can have equal sides or four of the sides can be rectangular; the macro-mesoporous coatings can be as described above.

The porosity of the individual particles in the slurry is preferably in the range of 0.7-0.96; the mesopore volume range is 0.4 cc/g-1.5 cc/g; the most prevalent mesopore diameter is in the range of 10-50 nm; the thickness of the final dried and sintered coating is in the range 2-15 mil. The sorbents can be aminopolymers, such as polypropylenimine (PPI), polyallylamine (PAA), polyvinylamine (PVA), polyglycidylamine (PGA), zeolites, etc.), blends of polymers (aminopolymers with each other, aminopolymers with PEGs, phenyl core polyamines (PhXYY), etc.), chemically modified polymers, polymers+ additive blends, metal organic frameworks (MOFs), porous organic frameworks (POFs), and covalent organic frameworks (COFs).

The amino polymers can be branched, linear, hyperbranched, or dendritic; the polymers can have a molecular weight in the range of from 500-25000 Da; the mesopore volume occupancy (pore filling) range can be from 40 to 100%; the macropore volume occupancy (pore filling) is in the range of from 0-15%, and should be minimized to avoid interfering with the flow of the mixed gases through the coating and into the mesopores of the individual particles, and ultimately out through the channels extending through the structural substrate.

The cost for heating the structural substrate as a thermal mass, of all of these monoliths, should be minimized, especially by minimizing the mass of any structural substrate. Furthermore, the thinner the wall thickness between channels, of the structural substrate, the higher the capacity for CO2 adsorption, as more macro-mesopore coating can be applied for the same pressure drop, yielding a higher volume of the sorbent within the porous system that can be reached by the flow of the CO2-laden air or other mixed gas flow.

The macroporous structure of macro-mesopore coating is formed on the surface of the channel walls. The macroporous structure of the porous coating is intended to provide the higher support volume for holding the sorbent in a morphology that is accessible to CO2 over the timescales needed to maximize production of CO2 per volume of a full-size monolith. The slurry of mesoporous particles is wash-coated onto the channel walls of the preformed structural substrate in either a single or multiple sequential coating steps, to build the macro-mesopore coating to the thickness that is desired.

The macro-mesopore coating is preferably formed from a slurry of mesoporous particles by drying and sintering together the particle slurry coated on the surface of the channel walls. The inter-particle volumes within the sintered coating define the macropores, which are formed by the spaces between the sintered particles.

The mesopore volume within the sintered coating in some embodiments of this invention contains mesopores preferably within the range of 10 nm to 50 nm diameter and optimally within the 20-40 nm range.

### Further Aspects of the Present Invention:

The present invention provides further new and useful improvements to previously described DAC systems, apparatus and methods for removing carbon dioxide from a mass or stream of carbon dioxide-laden air, at higher efficiencies and lower overall costs—including lower capital expenses (“CAPEX”) and lower operating expenses (“OPEX”).

In accordance with one of several preferred embodiments of the present invention, a novel process and system has been developed utilizing an assembly of a plurality of separate CO2 capture structures, each supporting substrate capture structure, as described above, or capture structures of substrate particles, are combined with a single regeneration box, in a ratio dependent upon the ratio of the speed of adsorption from ambient air, or from whichever gas mixture is being treated to remove CO2, compared to the speed of regeneration of the captured CO2-laden sorbent. In preferred embodiments, the CO2 capture structures are supported on a closed loop track, preferably forming a closed curve; the CO2 capture structures move longitudinally along a loop defined by the track, in succession, while being exposed to a moving stream of ambient air or a mixture of gases comprising ambient air. Alternatively, the capture structures can be moved longitudinally back and forth along an open-ended track.

At one location along the track, one of the CO2 capture structures is moved into a sealed chamber for processing, i.e., to strip CO2 from the sorbent and to regenerate the sorbent. When the sorbent is regenerated, the capture structure being regenerated leaves the regeneration chamber and the capture structures are rotated around the track until the next CO2 capture structure is in position to enter the regeneration box, and so on. The improvement of this invention provides for at least one of the capture structures to receive flue gas in place of ambient air, and preferably at least a majority of the other capture structures would be fed ambient air. Most preferably it would be substantially the last station before the regeneration box where the capture structures would receive the flue gas, or a mixture of ambient air with flue gas as the input.

In a preferred example the monoliths can complete one complete rotation along the track loop in about 1,000 seconds.

The velocity and concentration of the input flue gas mixture is independently controlled on the input side, though the output from the channels can be assisted by exhaust fans adjacent the exhaust side of the monolith. Ideally this could be a retrofit on to a pure DAC unit. It would enable the sorption of additional CO2, and preheat the sorbent array, by the sorption heat of reaction, before entering the regeneration box. The cool down of the array after the regeneration box could remain unchanged, though the heat removed might be used for other purposes, since the array was already preheated before regeneration began. The advantages of this integrated approach over a separate DAC and system for mixing a flow of ambient air and flue gas are as follows.

This approach, using a flue gas mixture at the last station before regeneration, increases the overall production of CO2 per DAC plant by an expected 30 to 50% and thus reduces the capex per yielded metric ton of captured CO2.

This approach reduces the capital cost of the flue gas capture component by using the same capital plant as the DAC.

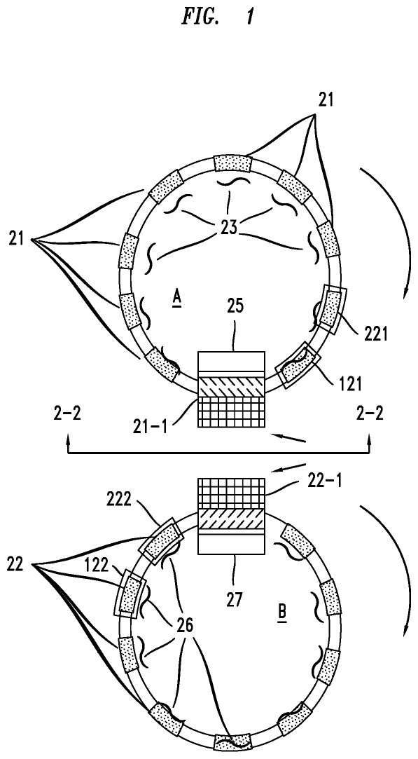

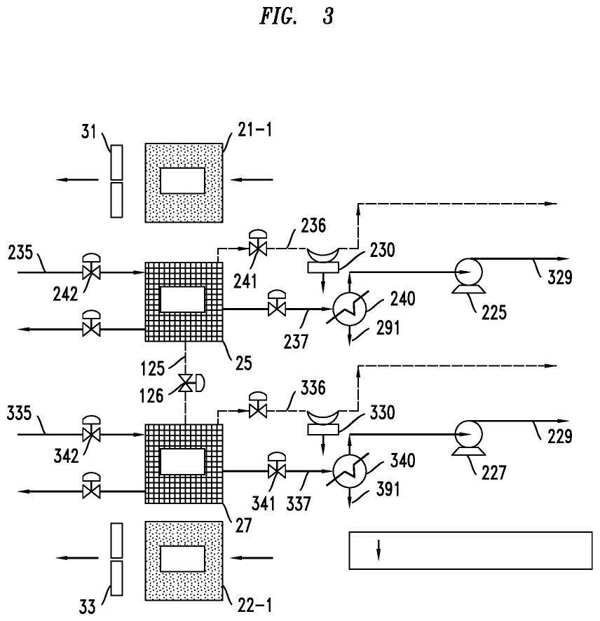

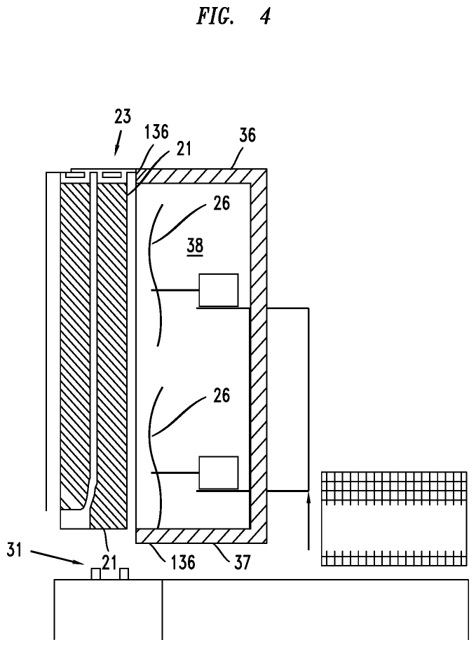

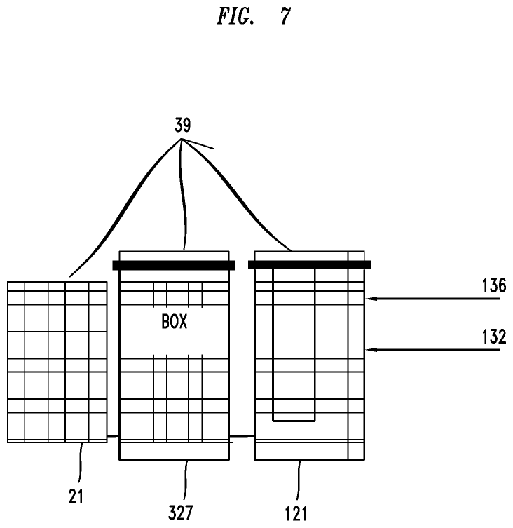

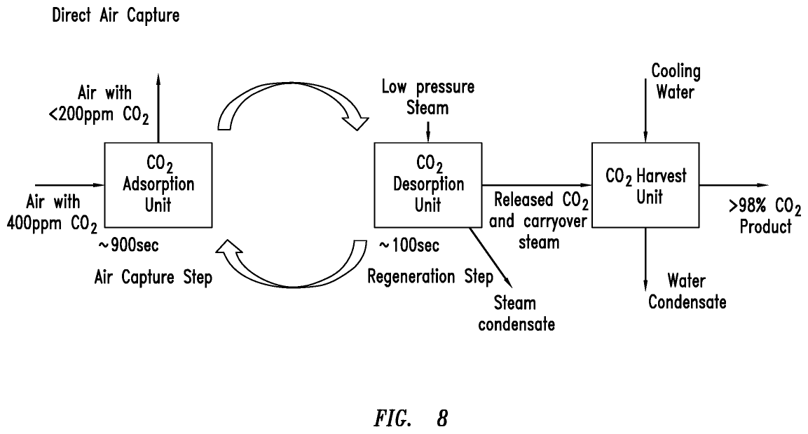

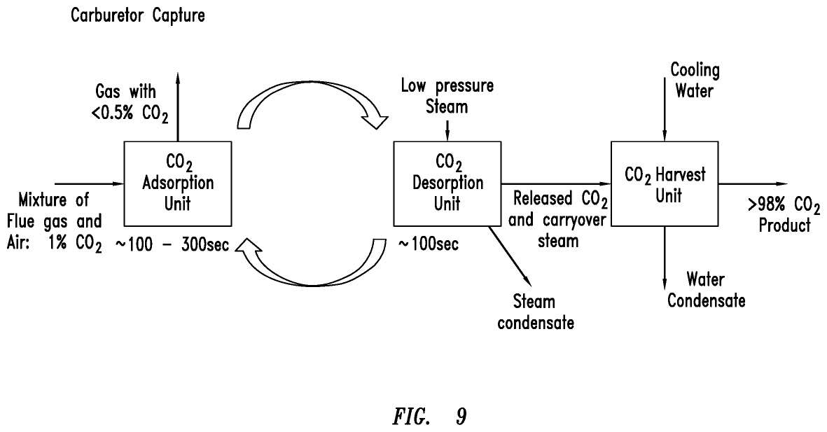

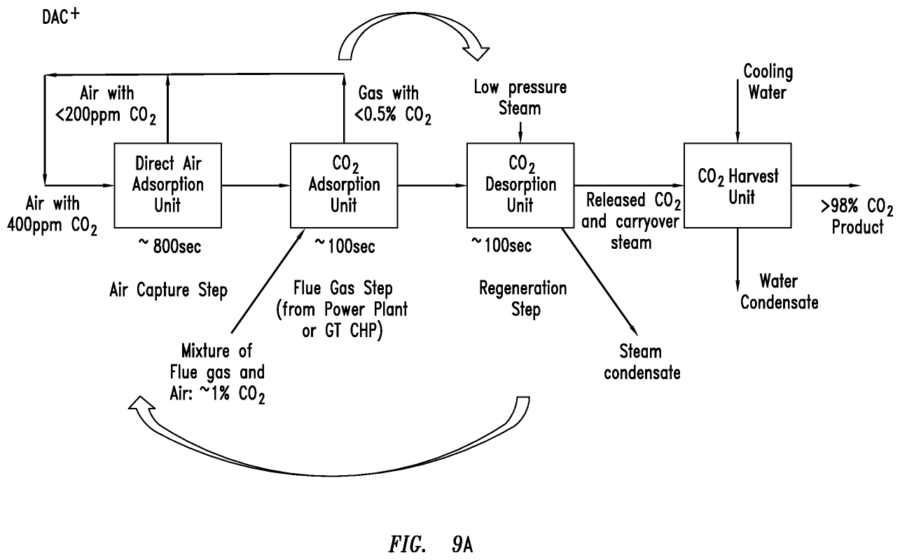

The energy used per tonne of CO2 produced is reduced
(A) because the amine sites binding the high concentration CO2 flue gas mixture increase the amounts of CO2 held by the sorbent per unit time;
(B) because this system has more CO2 being captured for the same sensible heat; and
(C) because the higher temperature flue gas mixture will preheat the array. Examples of a system as described above is shown in the drawing FIGS. 1-10.

There are three cases to consider for this system:
(A) The standalone case where a heat & power cogeneration unit (hereafter: Cogen) is sized to provide the heat and power for the GT facility.
(B) as an adjunct to larger Cogen facility so the heat and flue gas CO2 available is larger than will be used for the DAC unit and excess electricity and heat will be generated.
(C) The case of a negative carbon power plant where one will be capturing the CO2 from the power source and sizing the DAC provided based upon the need to remove the flue gas CO2 as well. (In this case one can choose the amount of flue gas CO2 captured based upon costs because the facility overall is carbon negative (e.g., removing more CO2 than would otherwise have been emitted without capture).
(D) The interesting observation is that for all three cases the same design holds; all that one is changing is the size of the Cogen plant being determined in [A] by our DAC energy needs, in [B] the energy needs of the specific application (compression, etc.), and in [C] by the size of the carbon negative power plant.

When an adjacent plant is a power plant, the product of such plant including cogenerated or surplus steam and electricity for operating the DAC plant is provided. The effluent flue gas from such power plant is at least partially cleaned before the effluent is fed to the final stage of CO2 capture, immediately prior to entry into the regeneration chamber. In addition, a partially pre-treated, CO2 reduced effluent can be used either alone or in admixture with ambient air in the eighth position, i.e., the position or stage immediately preceding, the flue gas capture stage of the system shown especially in the attached drawing figures of FIGS. 1, 7, and 9; it is understood of course that where there are, for example, 10 capture structures, with a single regeneration chamber, the regeneration chamber is the 10^{th} stage and the immediately preceding capture structure stage, before the capture structure enters the regeneration chamber, is the 9^{th} stage, and the second preceding stage is the 8^{th} stage. Examples of suitable structures for the system is shown in the drawings and descriptive text below.

Another preferred embodiment provides for the CO2-laden feed to include a previously partially captured flue gas, for example the exhaust from the final or last capture structure or the exhaust from a conventional CO2 removal system, conventionally used in industries having large CO2 containing exhaust, such as fuel burning power plants, cement manufacturing plants, steelmaking plants, and the like. Such systems involving the pretreatment of the effluent, are especially important when dealing with the exhaust from either solid, e.g., coal, or liquid e.g., petroleum oil, combustion process, which often include fine particulate matter, solid or liquid particles, and noxious gases.

A further preferred embodiment is a situation where a plant produces fuel intended for sale or use in other locations, from the CO2 produced from the plant of the present invention (e.g., via synthetic fuel production with H2).

### Porous Substrate:

As explained above, the present process however is a low temperature (e.g., preferably ambient—100° C.) semi-continuous process, with mass transport of the gas through the pores and sorbent at each phase of the process. Further, in one preferred embodiment the sorption reaction occurs on a sorbent impregnated within the macro-mesoporous coatings on the channel walls through a monolithic substrate. In such circumstances, the macroporosity is most preferably tuned to maximize pore volume rather than surface area. In order to accomplish this preferred situation, the preferred substrates are formed of structurally stable substrate having porous coatings covering the channel wall surfaces of the substrate. Although such coatings have been used in the production of catalytic structures, the preferred sorbent capture structures of this invention require significantly thicker porous coatings than traditional catalytic contactors with completely different preferred pore size and distribution due to the importance of total pore volume rather than total surface area of the channel walls.

One embodiment of the sorbent-supporting capture structures useful for the present invention can include a framework that supports the substrate along a closed loop or open-ended line along which the framework moves during the CO2 capture process. The framework supports a structural substrate, having a porous coating, and an impregnated sorbent within the pores of the coating.:

In one preferred embodiment a structural substrate has a primary purpose to provide structurally stable geometry to the macro-mesoporous surface coating, which in turn sets the cell density, channel shape, pore size and the like. The macro-mesoporous coating must have good physical/chemical adhesion with the channel walls. Because the substrate, in most embodiments of this invention, is otherwise inert, the substrate thickness, mass, and thermal mass should be minimized to minimize OPEX (costs of heat from thermal mass, electricity from pressure drop) and CAPEX (lower area fraction as substrate=higher capacity for CO2 capacity).

The macro-mesopore coating should be provided for the channel walls of substrates providing from 64 CPSI-600 CPSI. Generally, with the available mesoporous particles, sintered or otherwise cohered, a higher CPSI results in a higher pressure drop to enable full passage of the CO2 containing gas mixture through the channels; moreover, the relative proportion of cell density and coating thickness also determines pressure drop; as channel opening density increases, the minimum substrate wall thickness decreases (mechanical stability).

It has been found the macro-mesoporous coating provides the best activity/stability for amine sorbents when the mesopore size is in the 15-40 nm range. For the macropore size, i.e., the distance separating the mesoporous particles, is preferably at least greater than 200 nm. However, in order to avoid unnecessary reduction in the active volume of mesopore volume, reducing maximum potential capacity, the macropore size should be maintained in a range closer to 200 nm as opposed to significantly larger pores (micron sized and above). In other words, for preferred embodiments of this invention macropore volume should therefore be optimized for the minimum amount of macroporosity to provide fast access for a CO2-containing gas mixture to the mesopores.

Ultimately determining the necessary minimum mesoporosity is a function of coating thickness—thinnest walls require minimal macroporosity (but have the least bulk sorbent capacity), while thicker walls, having greater sorbent capacity, require more macroporosity for access. Macro-mesoporous coat thickness is ultimately limited by the pressure drop of the mesoporous particles—for a given pressure drop constraint (e.g., 200 Pa) and a given approach velocity (e.g., 5 m/s), the maximum washcoat thickness is determined by calculating the maximum total wall thickness for a given CPSI, then subtracting out the substrate thickness.

Generally, the thicker the wall macro-mesopore coating, the more volume is potentially available for active mesoporosity. However, the thicker the wall, the harder it is to access the full depth of the wall in the working capacity timeframe, which requires an increased microporosity; the most efficient thickness is determined as a function of the CPSI and the available pressure drop for the flow of gas mixture.

When considering a desirable impregnated aminopolymers sorbent, polyethyleneimine (PEI) has been the sorbent most used up until now; PEI provides the necessary high amine density, commercially available at scale, to provide the high activity at low CO2 concentrations when treating ambient air. However, the well-known problem for PEI is oxidative degradation at elevated temperatures.

Other preferred aminopolymers that can be used as sorbents, include those with varying degrees of primary, secondary, and tertiary amines, as well as varying backbone chemistries, molecular weights, degrees of branching, and additives, such as PPI, PGA, PVA, PAA; in addition, other possible sorbents include blends of polymers (aminopolymers with each other, aminopolymers with PEGs, etc.), chemically modified polymers, polymers+ additive blends, MOFs, zeolites, etc. The polymers can be branched, linear, hyperbranched, or dendritic. In general, these polymers are available having molecular weights ranging from 500-25000 Da. The sorbent structure or molecular weight can be limited by the mesopore size.
a. The extent to which the polymer occupies space within the mesopore is crucial in the material's performance, due to the problem of steric hindrance. For example, because of the size of the PEI molecule, the amount of PEI in mesoporous coating can be 70% mesopore volume filling, although a. 20%-150% may be possible. The steric hindrance effect, relevant to mesopore size, of other possible CO2 sorbents listed above, must be considered.

### Analysis:

In general, one will capture from the flue gas an extra fraction FGCO2FGCO2 per DAC cycle, when including the flue gas station in the final or penultimate stage, as compared to the DAC alone, leading to a CO2 production per cycle of DACCO2 (1+FGCO2) per cycle. Where FGCO2 is based upon a predetermined value of amine efficiency at the higher concentration. To first order the CAPEX per tonne will decrease by 1/(1+FGCO2) compared to a pure DAC embodiment. FGCO2 is based upon the increased amine CO2 capture efficiencies with increased concentration of CO2, which can range from 0.5 to 1. The extra fraction will vary with sorbent chosen. The capex cost of a separate carburetor and DAC plants producing the same total CO2 is larger by the amount FGCO2/(1+FGCO2) (FGCAPEX per tonne).

The calculations for determining the energy requirements are described for the capture structures moving a loop as shown in the drawings attached hereto, is set forth more fully and can be learned from International Application No. PCT/US2020/061690, filed on 21 Nov. 2020 (21.11.2020).

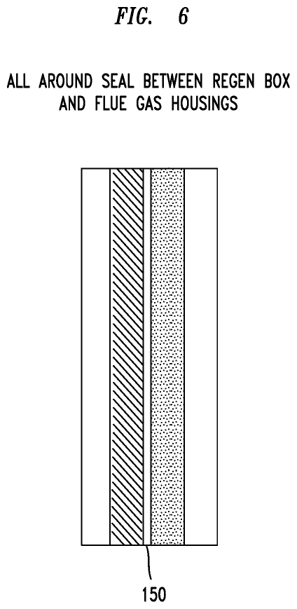

Once sealed within the regeneration box, the sorbent is treated to cause the CO2 to be stripped from the sorbent, regenerating the sorbent. The stripped CO2 is removed from the box and captured. The capture structures with the regenerated sorbent then moves out of the sealed box and moves along the loop defined by the track with the other capture structures to adsorb more CO2, until the next capture structure is moved into position to be moved into the regeneration box. At the stripping/regeneration location, the capture structures can be moved into a box located on grade of the track, so that the capture structures move into the stripping/regeneration box at the same grade level as the track, forming a seal with the capture structures, as shown by FIG. 6. These several alternatives are further defined below and diagrammed in the accompanying drawings.

In systems where the regeneration box is on grade with the tracks, sealing arrangement will be required, for providing a seal along the sides as well as along the top and/or bottom surfaces of the capture structure, as it moves through the regeneration chamber. (See FIG. 6)

### CO2 Adsorption and Removal Process

The basic premise of this process is that CO2 is adsorbed from the atmosphere by passing air or a mixture of air and effluent gas, through a sorbent capture structure, preferably at or close to ambient conditions. Once the CO2 has been adsorbed by the sorbent, the CO2 has to be collected, and the sorbent regenerated. The latter step is performed by heating the sorbent with steam in the sealed stripping/regeneration box to release the CO2 and regenerate the sorbent. The CO2 is collected from the box, and the sorbent is then available to re-adsorb CO2 from the atmosphere. The only primary limitation on the process is that the sorbent can be de-activated sooner if exposed to, e.g., atmospheric oxygen at temperatures that are too high. Thus, the sorbent may have to be cooled before the capture structure leaves the box and is returned to the air stream. The improved process of this invention, in one embodiment, is provided by passing flue gas, preferably in a purified form after removing any particulate solid or liquid material and any gaseous materials toxic to the sorbent, through the capture structure at its final stage before entering the regeneration chamber. This flue gas flowing stage is preferably carried out in a closed chamber such that the pre-treated flue gas is unable to escape into the environment before passing over and through a major surface of the porous monolith in the capture structure.

As a general rule, a longer time is required for adsorption of CO2 from ambient air than needed for the release of the CO2 in the regeneration step, or from the flue gas, with its far greater concentration of CO2. With the current generation of sorbent this difference will require an adsorption period approximately ten times greater for the adsorption step from air, compared with that required for CO2 release and sorbent regeneration, when treating ambient air. Thus, a system with ten capture structures and a single regeneration unit has been adopted as the current preferred basis for an individual CO2 capture unit. Other systems with the number of capture structures other than ten are contemplated as coming within the scope of the present invention, dependent upon the total time to reach the desired CO2 adsorption level on the capture structures before they enter the stripping/regeneration chamber.

If the performance of the sorbent is improved over time, this ratio of adsorption time to desorption time, and thus the number of capture structures required in a system, could be reduced. In particular, if a higher loading sorbent is used, and the ratio of adsorption-to-desorption times are increased, the number of capture structures perregeneration box could be reduced to, e.g., only five capture structures. In addition, the relative treatment times will vary with the concentration of CO2 in the gas mixture treated, such that the higher the CO2 content, the shorter the adsorption time relative to the regeneration time, e.g., by mixing a combustion effluent (“flue gas”) with the ambient air through a gas mixer.

To ensure more complete removal of the CO2 from the flue gas, the effluent from the ninth, or final stage, is passed into a second chamber in the eighth stage of the treatment in the capture structures.

The entire process of the present invention remains a low (i.e., ambient to 100 C or less) temperature process. Further, the reaction preferably occurs on polymer impregnated within the void volume of the porous coating on the channel wall surfaces of the substrate, so the coatings are tuned to maximize pore volume rather than surface area.

The chemical and physical activities within the capture structures, both during at least the first 7 stages of the adsorption cycle and the regeneration cycle in the sealed box, are substantially the same as is described in International Application No. PCT/US2020/061690. The disclosures of that patent application with respect to such activities are incorporated by reference herein as if repeated in full, as modified by the new disclosure presented herein.

In the system according to the present invention, and in the earlier patents, each movement system provides one sealable regeneration box for each group of rotating capture structures, the number of capture structures being dependent upon the relative times to achieve the desired adsorption and the desired regeneration. In addition, it has been found that greater efficiencies and lower costs are achieved by spatially relating and temporally operating two of the rotating systems in a suitable relationship to allow the regeneration boxes for the two rotating capture structures systems to interact, such that each is preheated by the remaining heat in the other as a result of regeneration in the other; this also efficiently cools down the regenerated capture structures before they are returned to its adsorption cycle on the rotating track.

This interaction between the regeneration boxes is achieved in accordance with this, combined with earlier inventions, by lowering the pressure of the first regeneration box to complete regeneration so that the steam and water remaining in the first box evaporates after the release of CO2, and the system cools to the saturation temperature of the steam at its lowered partial pressure. Furthermore, as described below, the heat released by this procedure is used to pre-heat the second sorbent capture structure and thus provides approximately 50% sensible heat recovery, with a beneficial impact on energy and water use. This concept can be used even if an oxygen-resistant sorbent is utilized. The sensitivity of the sorbent to oxygen de-activation at higher temperatures is addressed during the development process and it is anticipated that its performance will be improved over time. It should be understood that due to the greater concentration of the direct flue gas injection in at least the stage just preceding the regeneration box, and possibly in the next preceding one or more stages, the sorbent and substrate will be at a higher temperature due to the greater concentration of CO2 being adsorbed onto the sorbent, and the exothermic nature of the sorption reaction. This can allow for avoiding the necessity of reducing the pressure in the regeneration chamber to as low a vacuum as required when dealing with the treatment of ambient air alone or when mixed with a minor proportion of a flue gas. One example of such a more oxygen-resistant sorbent is described in U.S. Patent Publication No. 2014-0241966.

As discussed in the earlier patents and applications identified above, the sorbent capture structure is preferably cooled before it is exposed to air so as to avoid de-activation by the oxygen in the air. It is possible to utilize sorbents that have a greater resistance to thermal degradation, such as among the amines polyallylamine and polyvinylamine, as described in copending application Ser. No. 14/063,850. This cooling, if necessary, can be achieved by lowering the system pressure and thus lowering the steam saturation temperature. This has been shown to be effective in eliminating the sorbent deactivation issue as it lowers the temperature of the system. There is thus a significant amount of energy removed from the capture structure that is cooled during the de-pressurization step. A fresh capture structure that has finished its CO2 adsorption step has to be heated to release the CO2 and regenerate the sorbent. This heat could be provided solely by the atmospheric pressure steam, but this is an additional operating cost. In order to minimize this operating cost, a two-capture structure design concept has been developed. In this concept the heat that is removed from the box that is being cooled by reducing the system pressure, and thus the steam saturation temperature, is used to partially pre-heat a second box containing a capture structure that has finished adsorbing CO2 from the air and which is to be heated to start the CO2 removal and sorbent regeneration step. Thus, the steam usage is reduced by using heat from the cooling of the first box to increase the temperature of the second box. The remaining heat duty for the second box is achieved by adding steam, preferably at atmospheric pressure. This process is repeated for the other rotating capture structures in each of the two boxes and improves the thermal efficiency of the system.

### Acronyms

The several acronyms used herein can be defined as follows:
FGCO2=fraction of CO2 relative to air CO2 captured per cycle that is flue gas DACCO2=amount of air CO2 captured per cycle
FGCAPEX=flue gas capex in a pure carburetor embodiment M*=total natural gas burnt in MMBTu
M=useable heat and electricity produced COGENE=cogen efficiency=M/M* FGCCO2=Flue gas CO2 captured per year DACCO2=air CO2 captured per year
FTCO2=total flue gas CO2 produced in burning M* natural gas
MTCO2=total CO2 captured per year −sum of flue gas and air captured per year ECF=efficiency of flue gas capture
MDAC=energy per tonne of air CO2 captured MFG=energy per tonne of flue gas CO2 captured SHA=sensible heat of monolith array
Delta HR=difference in heat of reaction between DAC CO2 and flue gas CO2 sites
THF=total heat sources in flue gas steam −sensible heat+ CO2 heat of reaction+water condensation heat−need to keep straight low and high heat value of natural gas to make things consistent

In one embodiment of the present invention, the macropore size should be slightly greater than 200 nm, and more broadly in the range of between 200 and 1000 nm in diameter. The efficient transport of air rich with CO2 to the mesopores is the reason for the larger size diameter of the macropores.

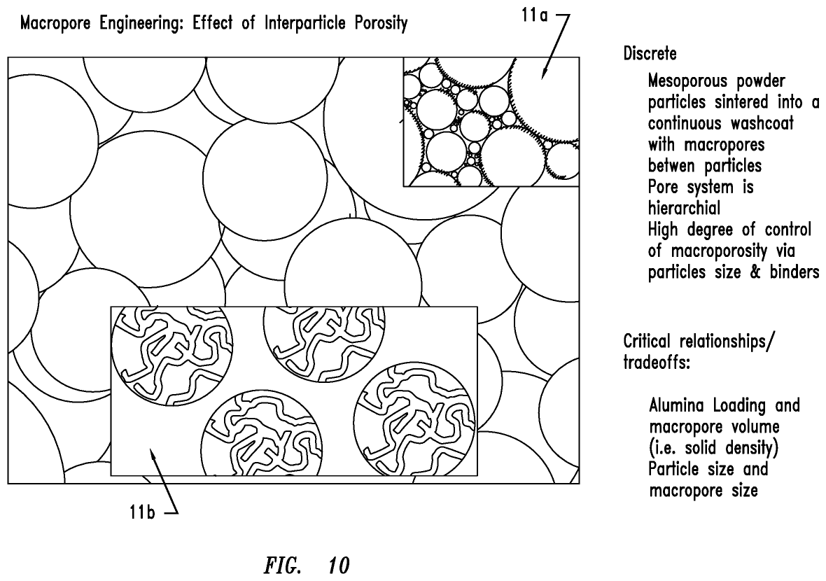

The use of particles that are of substantially uniform size can allow for the preparation of macropores of predetermined diameter. However, where the particle sizes vary between significantly different smaller and larger sizes, or where the particles are not uniformly compact in all dimensions, forming a predetermined pore diameter is more difficult as shown in the diagram of FIG. 10. The larger interparticle pore size, up to a point, the faster will be the gas mixture flow. But above a certain size, as stated above, the system becomes less efficient because there are fewer mesopores.

The mesoporous structure is a function of the structure of the individual particles. It is thus possible to have a fairly high degree of independent control of macroporosity by particle size and size distribution, and the nature of the liquid forming the slurry.

The presently preferred sorbents are amino polymers, with Polyethyleneimine (“PEI”) as the generally used sorbent material. This provides the desired sorbent activity for low CO2 concentrations, such as are found in ambient air. High amine density is achieved using commercially available products. However, there will be oxidative degradation at elevated temperatures and, therefore, cooling is required between the regeneration procedure, and returning the sorbent to the air.

Other amino polymers can also be used and have been used as sorbent with varying degrees of primary, secondary and tertiary as well as varying polymer backbone molecular weight degrees of branching and additive material. Other amino polymers that have been used include polypropylene amine polyglycols and the polyvinyl and polyallylamines, which provide greater oxidation resistance.

It is desirable to know the approximate mesopore volume within the washcoat. The preferred loading target for the polymer is to fill 70% of the mesopore volume in the washcoat with sorbent. This optimum quantity can vary depending upon the particular sorbent used, its molecular weight, and coating macroporosity.

In determining the effective particle size for forming the desirable macro-mesoporous coat, determine the microporous/mesoporous volume ratio. As a general calculation, if time=T, the CO2 molecule can diffuse up to a distance X into the pore, and the relative penetration depth ability of the CO2 molecule is given as X/L, where L is the total length of the pore. L will generally scale with the radius of the particle “R”, so as the particle radius increases, the penetration depth capability of the CO2 decreases. If X/R is less than 1, some portion of the interior of the particle is inaccessible via diffusion during the duration of adsorption, thus decreasing the CO2 capture efficiency of the material. Thus, although smaller particles provide a shorter diffusion length and thus better utilization of active sites containing the sorbent, smaller particles yield smaller interparticle length, and therefore smaller macroporosity, reducing the speed of the diffusion of CO2 to the mesopore on the particle surface. Accordingly, the microporous/mesoporous volume ratio must be balanced to achieve the optimal efficiency.

### More Detailed Invention Description

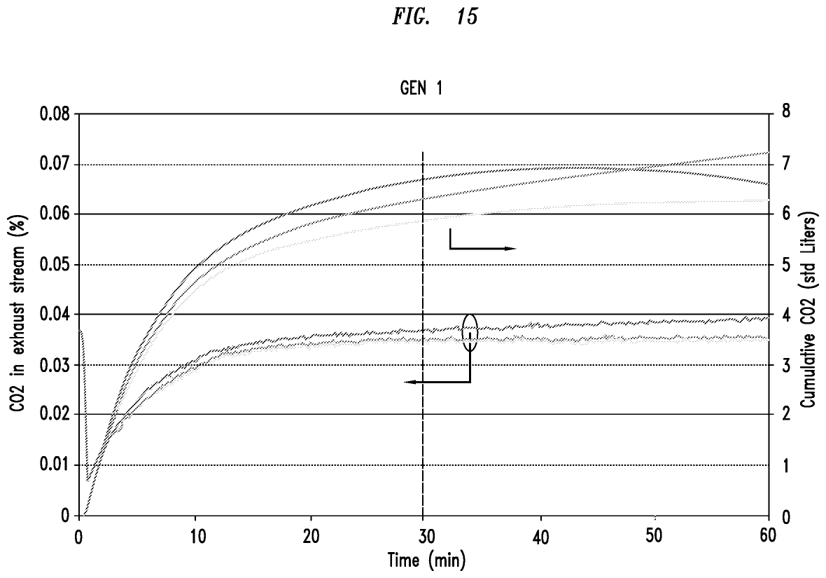

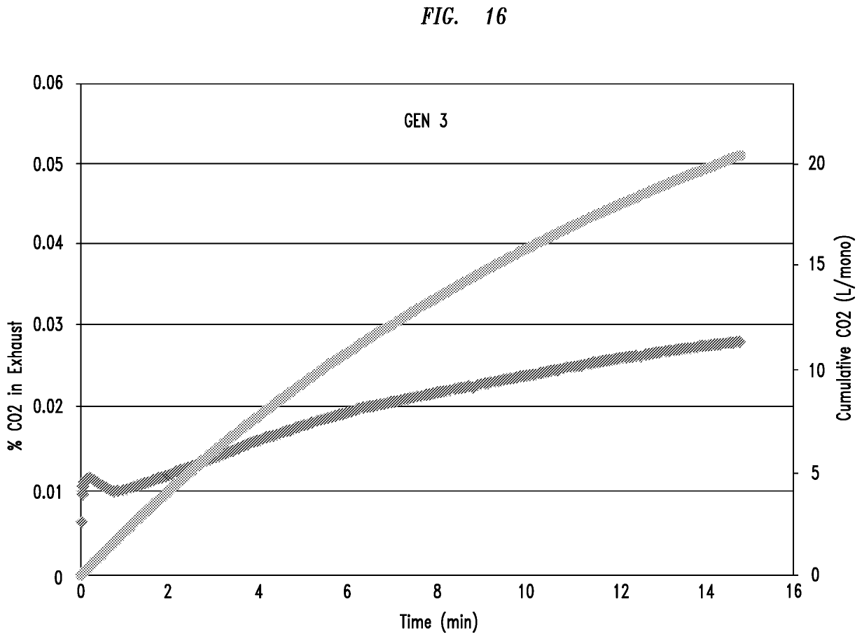

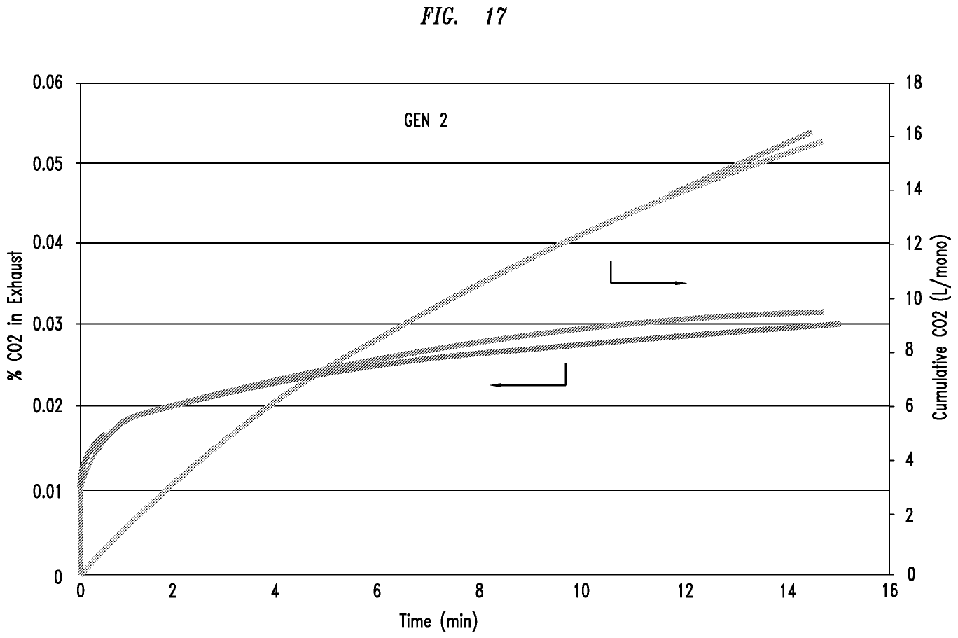

A conceptual design for a system to perform these operations is shown in FIGS. 1 through 10. A detailed discussion of the operation and the ancillary equipment that will be required is set out above and below and is similar to that shown in International application No. PCT/US2020/061690, filed on 21 Nov. 2020 (21.11.2020). The washcoat and sorbent characteristics of preferred embodiments of the present invention are summarized in FIGS. 10-16.

Examples of a physical embodiment of a structure for utilizing an embodiment of this invention, are depicted in the drawings. As shown in FIG. 1, there are ten “capture structures” located in a decagon arrangement and which are located on a continuous loop track. There are two such continuous loop decagon assemblies associated with each process unit and they interact with each other as shown. In this preferred embodiment, air is passed through the capture structures by induced draft fans located on the inner sides of the capture structures. At one location the capture structures are in a position adjacent to a single sealable chamber box, into which each capture structure is inserted, as it moves along the track, for regeneration processing. In the sealable regeneration chamber box, they are heated to a temperature of not greater than 130 C, and more preferably not above 120 C, most preferably at a temperature of not greater than 100° C. with process heat steam to release the CO2 from the sorbent and regenerate the sorbent. In this embodiment, the adsorption time for adsorbing CO2 by the capture structures is ten times as long as the sorbent regeneration time.

It should be understood that although the use of porous monolithic substrates in the capture structures is preferred, it is feasible to use stationary capture structures of porous particulate, or granular, material supported within a frame on the capture structures. In both cases the porous substrate preferably supports an amine sorbent for CO2, when the particle capture structure has the same pore volume as the monolithic capture structures for supporting the adsorbent.

### Mechanical Requirements

The drawings depict in diagrammatic form the basic operational concepts of the system. In the embodiment depicted in FIG. 1, there are ten “capture structures 21, 22 located in each decagon assembly arrangement and which are movably supported on a circular track 31, 33. There are two circular/decagon assemblies A, B associated with each process unit and they interact with each other. Air or flue gas is passed through each of the capture structures s 21, 22 by induced draft fans 23, 26, located radially interiorly of each of the decagon assemblies, and inducing a flow of exhausted gas out of the inner circumferential surface of each capture structures, and up away from the system. At one location along the track 31, 33, the capture structures 21, 22 are adjacent to a sealable regeneration box 25, 27 into which the capture structures s 22, 22 are inserted for regeneration processing after having completed one rotation around the track.

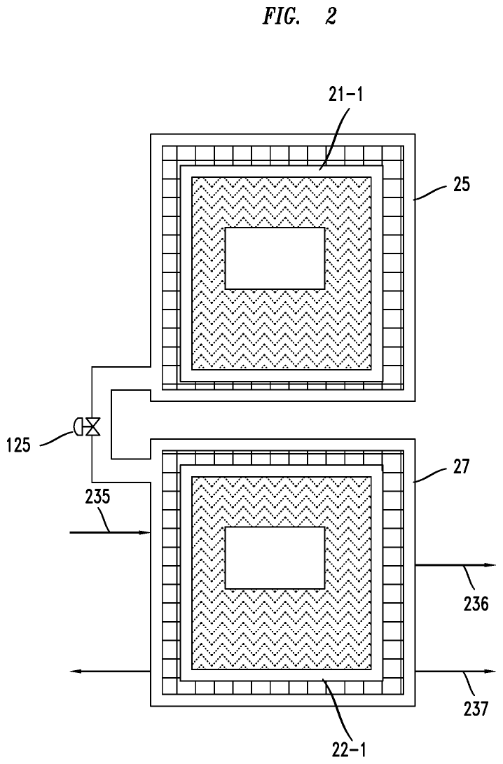

Thus, as shown in FIGS. 1 and 2, a first capture structure 21 is rotated into position within the regeneration box 25 for processing; When the capture structure 21 has been regenerated and the regenerated capture structure is moved out of the regeneration box 25, so that the next capture structure 21-2, 22-2 can be moved in after having treated the flue gas, as shown. This process is repeated continually. The two ring assemblies operate together, although the capture structures for each decagon are moved in and out of their boxes at slightly different times, as explained below, to allow for the passage of heat, e.g., between box 25 and box 27, when regeneration in one is completed to provide for preheating of the other box. This saves heat at the beginning of the regeneration and reduces cost of cooling the capture structure after regeneration.

The regeneration chambers 321, 327 are located on grade with the rotating capture structure assemblies. The boxes are located with adequate access for maintenance and process piping, also on grade. Suitable mutually sealing surfaces are located on the box and on each capture structure, so that as the capture structure rotates into position in the box, the box 322, 327 is sealed. There are also optional sealable chambers for the immediately preceding positions along the track for the feeding of flue gas or partially cleaned effluent gas into the capture structures. In this embodiment, it is possible to operate the system so that the capture structures move continuously along the loops.

In some embodiments of the present invention, ancillary equipment (such as pumps, control systems, etc.) can preferably also be located at grade within the circumference of the track supporting the rotating capture structure assemblies 29, 39. In other embodiments of the invention, ancillary equipment is located outside of the container that houses the panels.

An alternative design provides for a system where the pair of regeneration boxes, or chambers, 25 can move along the track. Compared to prior disclosed apparatus in the prior art, this would:
Minimize structural steel.
Place all major equipment at grade level apart from the regeneration boxes which are only acting as containment vessels.
Ensure that there is no interference with air flow to the capture structures, where the boxes are at different levels from the track.
Avoid movement of the larger multi-unit system of rotating all of the capture structures to move them into a regeneration box.
Allow the two regeneration boxes to be adjacent to each other with minimum clearance to permit the heat exchange desirable for increased efficiency.
The mechanical operations, with necessary machinery and power, that are required include:
   motors to power the movement of the two sets of capture structure assemblies around a closed loop defined by the track, continuously or intermittently; or
   motors to move the two regeneration chambers along their tracks; or
   precise locating elements to locate the position where the capture structures, or the regeneration chambers, are to be stopped so as to allow for the free passage of the capture structures into, through and out of the regeneration boxes, as the capture structures or boxes move.

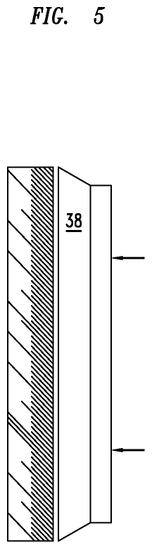

In the preferred embodiments of this system and method, referring to FIGS. 1-7, a capture structure 21-1 (Ring A), is rotated into position, or the regeneration chamber is moved so that the capture structure 21-1 is moved into and through the regeneration chamber. Box 25, for processing. The pressure in Box 25 (containing Capture structure 21-1, Ring A) is reduced using, e.g., a vacuum pump 230, to as low as 0.2 BarA. The Box 25 is heated with steam at atmospheric pressure through line 235 and CO2 is generated from Capture structure 21-1 and removed through the outlet piping 237 from the Box 25 for the CO2 and condensate which is separated on a condenser 240 (FIG. 5A). Capture structure 22-1 (Ring B) is then placed in Box 27 (Ring B) while Box 25 is being processed, as above (FIG. 5B). The steam supply to Box 25 is stopped and the outlet piping for the CO2 and condensate isolated. Box 25 and Box 27 are connected by opening valve 126 in connecting piping 125 (FIG. 5C).

The pressure in Box 27 is lowered using a vacuum pump 330 associated with Box 27. This lowers the system pressure in both boxes and draws the steam and inerts remaining in Box 25 through Box 27 and then to the vacuum pump. This cools Box 25 (and thus Capture structure 21-1 Ring A) to a lower temperature (i.e., the saturation temperature at the partial pressure of the steam in the box) and reduces the potential for oxygen deactivation of the sorbent when the Capture structure 21-1 is placed back in the air stream. This process also pre-heats Box 27 (and thus Capture structure 22-1 Ring B) from ambient temperature up to the saturation temperature at the partial pressure of the steam in the box 250. Thus, energy has been recovered and the amount of atmospheric pressure steam required to heat the second Box 27 (and Capture structure 22-1 Ring B) is reduced (FIG. 5D). As the vacuum pump 330 lowers pressure in the Boxes 25 and 27, the first Box 25 is reduced in temperature (from approximately 100° C. to some intermediate temperature) and the second Box 27 is increased in temperature (from ambient to the same intermediate temperature). CO2 and inerts are removed from the system by the vacuum pump 330.

The valve between the first Box 25 and the second Box 27 is closed and the boxes are substantially isolated from each other. Capture structure 21-1 Ring A is now cooled below the temperature where oxygen deactivation of the sorbent is of concern when the capture structure is placed back in the air stream. The second Box 27 and Capture structure 22-1, Ring B, have been preheated and thus the amount of steam required for heating the Box and Capture structure is reduced (FIG. 5E). Capture structure 21-1 Ring A is then moved out of the regeneration chamber, or the regeneration chamber moved away from the capture structure. The Ring A capture structure assembly is rotated, or the regeneration chamber is moved by one capture structure and Capture structure 21-2 Ring A is then inserted into regeneration chamber 25, where it is ready for preheating. regeneration chamber 25 is heated with atmospheric steam and the stripped CO2 is collected (FIG. 5F).

When the second regeneration chamber 27 (containing Capture structure 22-1 Ring B) has been fully regenerated, the steam supply to regeneration chamber 27 (Ring B) is isolated and the piping for the CO2 and condensate is opened to regeneration chamber 27, using valves 241, 242, to remove the CO2. The valving 126 between the first regeneration chamber 25 and the second regeneration chamber 27 is opened, after the pressure in regeneration chamber 25 has been reduced, using the vacuum pump 230 system for Box 25, and the pressure in the regeneration chamber 25, has been reduced, so that and in regeneration chamber 27 (Ring B) is reduced (see 5 above). The temperature in the second regeneration chamber 27 (containing Capture structure 21-2, Ring A) is increased (see 5 above) (FIG. 5G). The vacuum pump 230 lowers pressure in Boxes 25, 27. Box 25 is reduced in temperature (from 100° C. approx. to some intermediate temperature). Box 27 is increased in temperature. (from ambient to the same intermediate temperature). CO2 and inerts are removed from the system by the vacuum pump 230. Capture structure 22-1, Ring B, moves out of regeneration chamber as the assembly Loop B is rotated one capture structure, or the regeneration chamber is moved, so that Capture structure 22-2, Ring B, is then inserted into regeneration chamber 25. Shortly thereafter, regeneration chamber 25 moves relative to track Loop A (so as to sealingly contain Capture structure 21-2 Ring A). Regeneration chamber 25 is then subjected to reduced pressure by opening valve 340 and operating vacuum pump 227, to evacuate any air, and is heated with atmospheric steam from line 335, by opening valve 342, to release the CO2 and regenerate the sorbent (FIG. 5H). When regeneration is complete in regeneration chamber 25, the pre-heating of Box 27 by opening valve 126, in line 125, then occurs as described above. The process is repeated for all of the capture structures as the Decagons are rotated many times, or as the regeneration chambers are moved relative to the track loops A and B.

### Design Parameters

The current preferred bases for the design of the system shown in the drawings are as follows:
Weight of individual capture structures to be moved:
   1,500-10,000 lbs. (including support structure).
Approximate size of substrate support structure:
   Width—5-6 meters,
   Height—9-10 meters
   Depth—0.15-1 meter.
It should be noted that the capture structure dimensions can be adjusted depending upon the particular conditions at the geographic location of each pair of systems, and the desired, or attainable, processing parameters.

For a system including 10 capture structures in each of the Decagon loops, the outer dimensions of a preferred circular/decagon structure would be about 15-17 meters, preferably about 16.5 meters. The capture structures support structures could be individually driven, for example, by an electric motor and drive wheel along the track, or the support structures could be secured to a specific location along the track and a single large motor used to drive the track and all of the structures around the closed loop. In either case, the regeneration box is placed at one location and all of the structures can stop their movement when one of the support structures is so placed as to be moved into the regeneration box. The economics of a single drive motor or engine, or multiple drive motors or engines, will depend on many factors, such as location and whether the driving will be accomplished by an electrical motor or by some fuel driven engine. The nature of the driving units, per se, is not itself a significant feature of this invention, and are all well-known to persons skilled in the art. Examples of suitable engines include internal or external combustion engines or gas pressure driven engines, for example operating using the Stirling engine cycle, or process steam engines or hydraulic or pneumatic engines, or electrical motors. If the system operates in substantially continuous motion, a complete loop for each capture structure, preferably takes about 1000 seconds.

When a regeneration chamber is located on the track level, the top of the regeneration chamber will be about 20 meters above the grade of the track, which is only minimally above the tops of the capture structures in order to accommodate the capture structures wholly within the box during regeneration.

Parameters When Carrying Out The Process Of This Invention:

1. The flow of mixed gases into the capture structure in the several embodiments of this invention contain concentrations between 100-100000 ppm, but preferably between 400-30000 ppm (0.04% to 3% v/v). This is provided as a flow of ambient air or a mixture of an effluent, or flue, gas containing CO2 and air.
2. The temperature of the flow of mixed gases, in several embodiments of this invention, being between −25 to 75C, but preferably between 0 to 40C
3. The flow of mixed gases, in several embodiments of this invention, contain water vapor between 0-10% v/v, but preferably between 0.5-4% v/v.
4. In several embodiments of this invention, the flow of mixed gases move through the macroporous channels, and any longitudinal channels through a structural substrate, is at an average velocity of 2-10 m/s within each channel, but preferably between 4-8 m/s within each channel.
5. The flow of the above mixed gases, in several embodiments of this invention, contact mesopores in the monolith material by flowing evenly through each channel.
6. The CO2, in the flow of mixed gases, in several embodiments of this invention, contact the surface of the mesoporous walls containing the CO2 sorbent, by diffusion in the direction perpendicular to the flow of the CO2 containing gas through the mesooporous channels of the monolith.
7. The CO2 contacts the CO2 sorbent by diffusion from the bulk flow in the macroporous channels, of the wall coating, to the CO2 sorbent embedded within the mesopore void of the walls.
8. The rate of CO2 diffusion within the coatings the walls of the monoliths, in several embodiments of this invention, being similar or equal to the rate of CO2 diffusion in the longitudinal channels of the monolith.
9. The creation of a concentrated stream of CO2 and regeneration of the sorbent, in several embodiments of this invention, occur by desorbing CO2 bound to the CO2 sorbent within the mesopore void of the monolith, as a result of: increasing the temperature of the CO2 sorbent; by decreasing the partial pressure of CO2 contacting the CO2 sorbent; by contacting with process heat steam; and/or, by a combination of some or all of the above.
10. The increase in temperature and decrease in partial pressure of CO2 surrounding the CO2 sorbent occur, in several embodiments of this invention, as a result of condensing a saturated fluid on the surface of the monolith walls.
11. The condensation temperature of the fluid, referred to immediately above, being in the range of 60-130C, in several embodiments of this invention.

### EXAMPLES

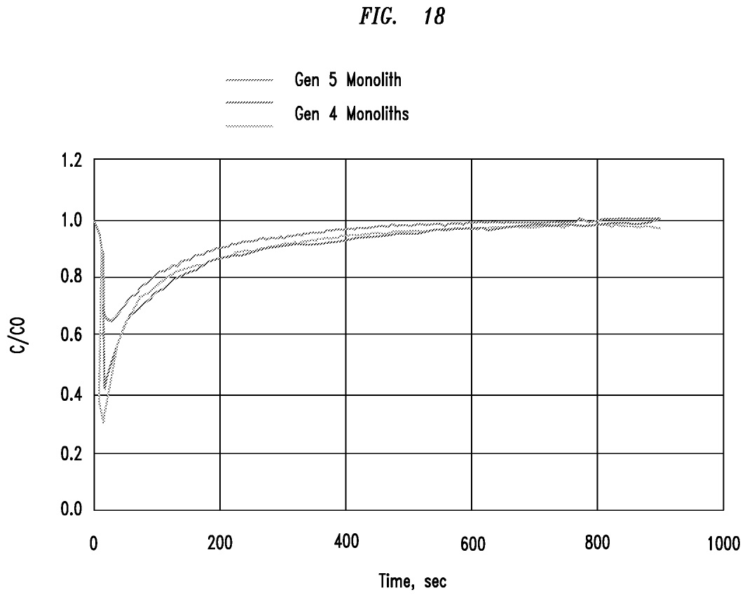

The following examples of embodiments of this invention have been carried out and the results are shown by the graphs of FIGS. 15-18:

### Example 1—Gen 1,3

A coated cordierite monolith is prepared having a cordierite structural substrate; the cordierite structural substrate has 6″ long longitudinal square channels extending therethrough between the two major sides to be coated. The structural substrate having 230 CPSI, with an 8 mil wall between the square channels.

A macro-mesoporous alumina coating is adhered to the two major opposing surfaces of the substrate, from a dried and sintered slurry of mesoporous particulate alumina. The coatings have a macroporosity of 0.85-0.92 and a mesoporosity of 0.9-1.0 cc/g. The mesopores have a median size of 20 nm and a median macropore diameter of about 1 micron, with a 1:1 macropore/mesopore ratio.

The coating on each side of the substrate is about 8 mil thick. The coatings are physically impregnated with polyethylene imine sorbent at a PF of 60-70%.

A stream of ambient air mixed with a minor amount of a pretreated flue gas having a CO2 concentration of about 0.1% v/v and water vapor concentration of about 4% v/v, is passed at a flow rate of about 5 m/s into the macropore openings in the coatings.

The results with respect to CO2 concentration in the exhaust gas from the regeneration chamber, and the total CO2 collected by the sorbent, over time, is shown in FIGS. 15 and 16.

### Example 2—Gen 2

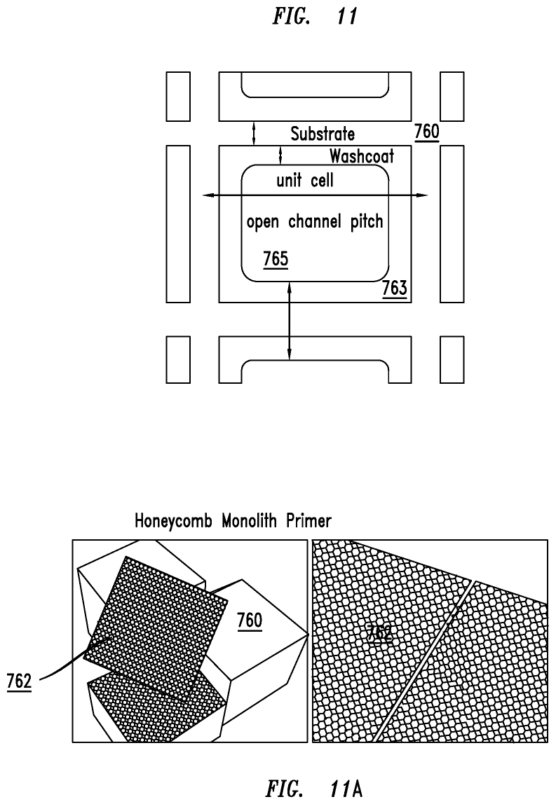

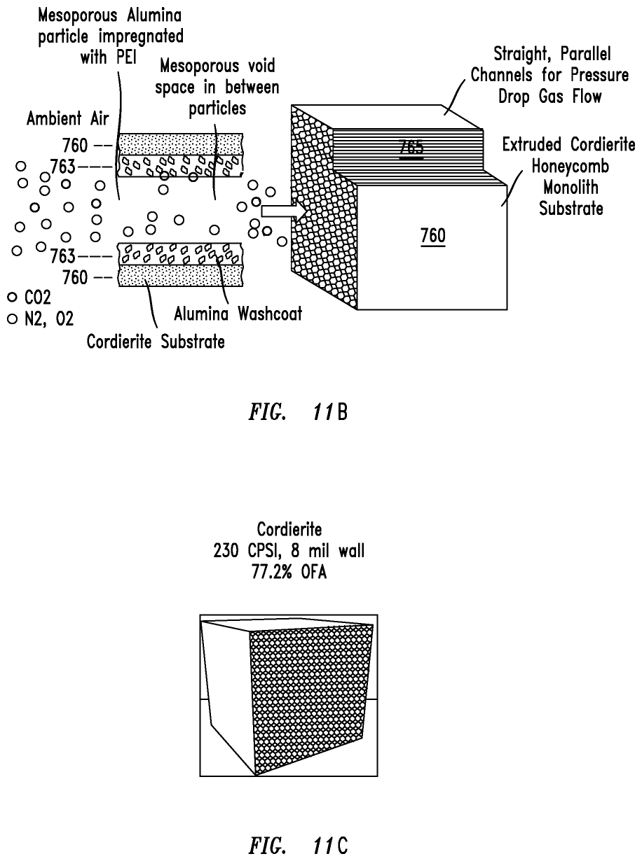

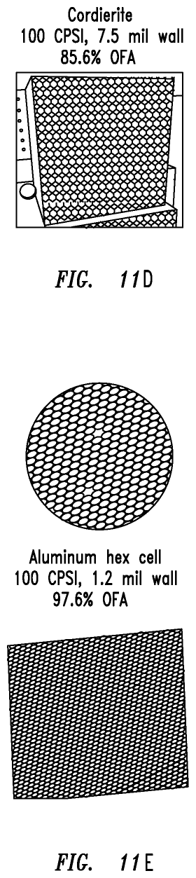

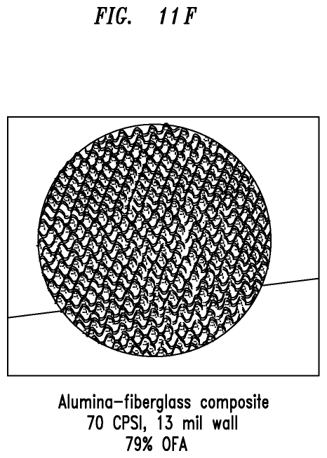

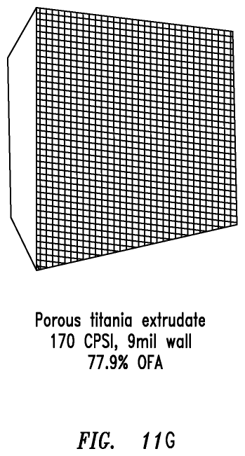

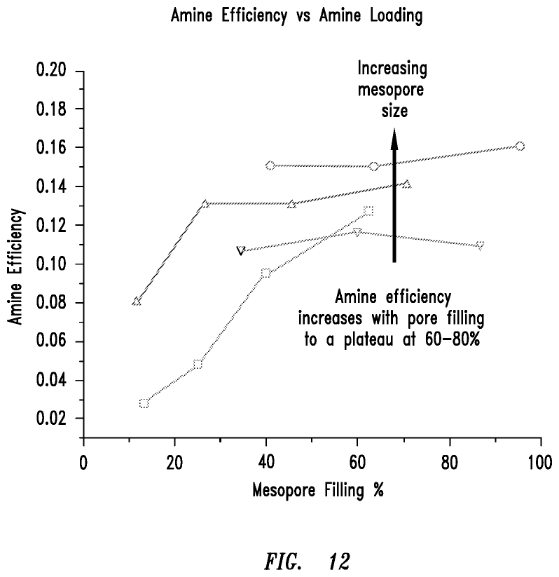

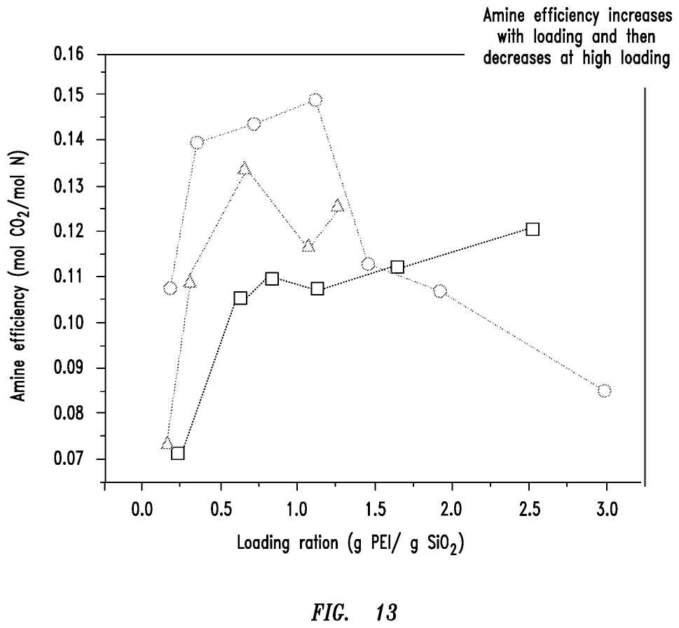

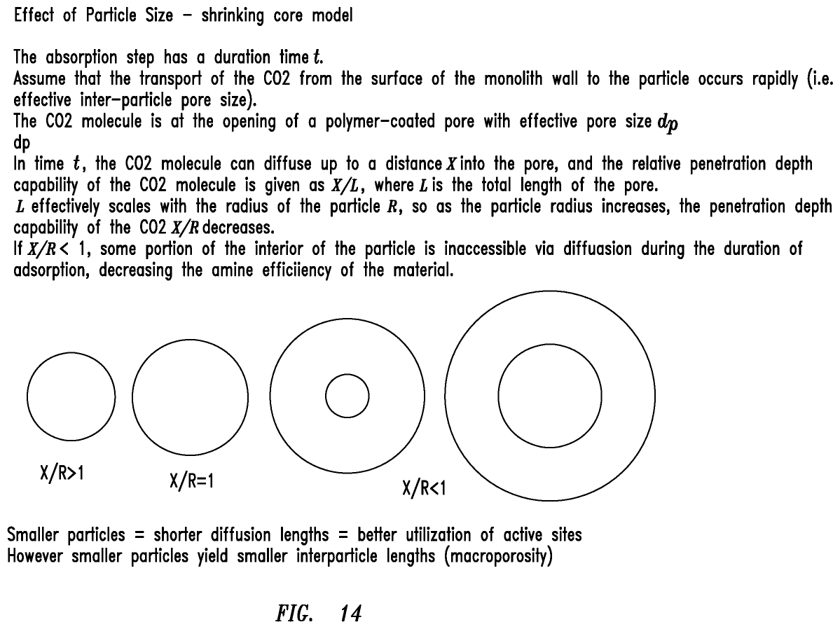

A coated corrugated fiberboard monolith is prepared having a corrugated structural substrate made of fiberglass, with 6″ long, longitudinal bell-curve channels extending therethrough, see FIG. 11F. Otherwise, the parameters are the same as in Example 1, above. The results of the tests are set forth in FIG. 17.

### Example 3—Gen 4

This example provides a mesoporous titania extrudate (Gen 4) as the homogeneous monolith, i.e., without any separate inert structural substrate. The mesoporous titania monolith of this Example is provided with 6″ long longitudinal square channels extending therethrough between the two major sides. The mesoporous titania monolith has 230 CPSI, with a 9 mil wall between the square channels, and a 0.6 porosity.

The microporous/mesoporous monolith has an overall macroporosity of 0.85-0.92 and a mesoporosity of 0.9-1.0 cc/g. The mesopores have a median size of 20 nm and a median macropore diameter of about 200 nm.

The monolith is physically impregnated with polyethylene imine sorbent at a PF of 60-70%.

A stream of ambient air mixed with a minor amount of a pretreated flue gas having a CO2 concentration of about 0.1% v/v and water vapor concentration of about 4% v/v, is passed at a flow rate of about 5 m/s into the macropore openings of the major surfaces of the monolith.

The results with respect to CO2 concentration in the exhaust gas from the regeneration chamber, and the total CO2 collected by the sorbent, over time, are shown in FIG. 18.

### Example 4

This example provides a mesoporous titania extrudate (Gen 4) as the homogeneous monolith, i.e., without any separate inert structural substrate. The mesoporous titania monolith of this Example is provided with 6″ long longitudinal square channels extending therethrough between the two major sides. The mesoporous titania monolith has 230 CPSI, with a 9 mil wall between the square channels, and a 0.6 porosity.
The microporous/mesoporous monolith has an overall macroporosity of 0.85-0.92 and a mesoporosity of 0.9-1.0 cc/g. The mesopores have a median size of 20 nm and a median macropore diameter of about 200 nm.
The monolith is physically impregnated with polyethylene imine sorbent at a PF of 60-70%.
A stream of ambient air mixed with a minor amount of a pretreated flue gas having a CO2 concentration of about 0.1% v/v and water vapor concentration of about 4% v/v, is passed at a flow rate of about 5 m/s into the macropore openings of the major surfaces of the monolith.
The results with respect to CO2 concentration in the exhaust gas from the regeneration chamber, and the total CO2 collected by the sorbent, over time, are shown in FIG. 18.

### Example 5—Gen 5

A coated metal structural substrate, formed of corrugated aluminum metal foil, is prepared having has 6″ long longitudinal Rhomboid/diamond/hexagonal shaped channels extending therethrough between the two major sides to be coated. The structural substrate having 100 CPSI, with a 0.2 mil wall between the channels.
A porous alumina coating, of 8 mil thickness, is adhered to the two major opposing surfaces of the substrate, which surfaces are open to the longitudinal channels; the coating is formed from a slurry of mesoporous particles that are dried and sintered to form the macro/mesoporous particulate alumina coatings on the two sides. The coatings have a macroporosity of 0.85-0.92 and a mesoporosity of 0.9-1.0 cc/g. The mesopores have a median size of 20 nm and a median macropore diameter of about 1 micron, with a 1:1 macropore/mesopore ratio. The results of the tests are shown in FIG. 18.
The coating on each side of the substrate is about 8 mil thick. The coatings are physically impregnated with polyethylene imine sorbent at a PF of 60-70%.
The coatings are physically impregnated with a polyethyleneimine to 60-70% PF.
A stream of ambient air mixed with a minor amount of a pretreated flue gas having a CO2 concentration of about 0.1% v/v and water vapor concentration of about 4% v/v, is passed at a flow rate of about 5 m/s into the macropore openings in the coatings.
The results with respect to CO2 concentration in the exhaust gas from the regeneration chamber, and the total CO2 collected by the sorbent, over time, is shown in FIG. 18.

To summarize: this present invention provides an effective product for forming a capture structure for capturing CO2 from ambient air, or from mixtures of ambient air with minor proportions of effluent gases rich in CO2, that can be described as follows:
1. A monolithic structural substrate with straight channels running axially
   a. Formed of: Cordierite, aluminum, fiberglass, fecralloy, other metals, inorganic oxides (alumina, titania, silica, etc.), ceramic, polymers (polyethylene, polypropylene, polycarbonate, etc.), carbon, etc. These materials
      i. Can be extruded, corrugated, templated, 3D printed, molded, etc. to form the 3D structure
      ii. Can be porous or nonporous, and preferably has longitudinal channels extending between the surfaces to be coated;
   b. Cell density 50-400 CPSI
   c. Wall thickness 0.2 mil-20 mil
   d. OFA 0.5-0.98
   e. Channel cross section geometry: square, hexagonal, cylindrical, bell-curve (think corrugated cardboard), diamond/rhomboid, etc.
   f. Length 3-24″
   g. That can be coated with a . . . .
2. Porous coating, via dipcoating intro a slurry (single or sequential) or some other coating method, followed by drying and sintering to form the solid coating adhered to the surfaces of the substrate, which is formed of cohered mesoparticles and forms macropores between the particles, applied to the substrate containing channels and walls as defined above.”
   a. The particles are formed of Inorganic oxide (alumina, silica, titania, etc.), porous mineral/ceramic (e.g., boehmite), etc. having a
      i. Porosity range 0.7-0.96;
      ii. A Mesopore volume range 0.4 cc/g-1.5 cc/g
      iii. Most prevalent mesopore diameter 10-50 nm
      iv. Thickness range 2-15 mil thick coating
      v. Macropore diameter range 0.1-2 micron
      vi. Macropore/mesopore ratio range 1:5-2:1 (20% macro-80% meso to 66% macro-33% meso)
   b. That can accept an . . . .
3. Active sorbent material
   a. Preferentially in the mesopores
   b. Physically impregnated or chemically bonded
   c. Aminopolymers (pei, ppi, paa, pva, pgam, etc), blends of polymers (aminopolymers with each other, aminopolymers with PEGs, etc.), chemically modified polymers, polymers+ additive blends, MOFs, zeolites, etc.
      i. The polymers being branched, linear, hyperbranched, or dendritic
      ii. The polymers having molecular weight range 500-25000 Da
   d. Mesopore volume occupancy (pore filling) range 40-100%
   e. Macropore volume occupancy (pore filling) range 0-15%
4. A monolith substrate as described above in (1) where the substrate itself is the porous media in (2) —“A homogeneous porous body, having no distinct interface between substrate and washcoat, but containing meso and macropores” and “A porous body with particles embedded within a fibrous network, the fibers providing the body structural integrity and the particle providing the body with meso and microporosity”:
   a. Material: inorganic oxides (alumina, titania, silica, etc.), ceramic, carbon, polymer, binders and fillers
   b. Cell density 64-400 cpsi
   c. Wall thickness 3-30 mil
   d. OFA 0.5-0.8
   e. Channel cross section geometry: square, hexagonal, cylindrical, bell-curve (think corrugated cardboard), diamond/rhomboid, etc.
   f. Length 3-24″
   g. Porosity range 0.3-0.9
   h. Mesopore volume range 0.2 cc/g-1.5 cc/g
   i. Most prevalent mesopore diameter 10-50 nm
   j. Macropore diameter range 0.15-2 micron
   k. Macropore/mesopore ratio range 1:5-3:1 (20% macro-80% meso to 75% macro-25% meso)
   l. That can accept an . . . .
5. Active sorbent material exactly as described above in (3)
6. And a system for that purpose that includes the above structure and a method for achieving the efficient and effective capture of CO2 from ambient air and other mixtures of gases.

The above examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments but should be defined only in accordance with the following claims and their equivalents.

All documents cited herein, including journal articles or abstracts, published or corresponding U.S. or foreign patent applications, issued or foreign patents, or any other documents, are each entirely incorporated by reference herein, including all data, tables, Figures, and text presented in the cited documents.

1-20. (canceled)

21. A method for removing CO₂ from a gas stream, the method comprising:
contacting a gas stream with a honeycomb monolith containing a CO₂ sorbent;
wherein the honeycomb monolith is comprised of longitudinal channels connecting two opposed surfaces of the monolith;
wherein the longitudinal channels comprise macropore and mesopore containing walls;
wherein the CO₂ sorbent occupies a fraction of a mesopore volume within the macropore and mesopore containing walls;
removing CO₂ from the gas stream by sorbing CO₂ using the CO₂ sorbent as the gas stream flows through the longitudinal channels; and
removing the sorbed CO₂ from the CO₂ sorbent by heating the honeycomb monolith to about 60° C. to 130° C.;
wherein an amount of time taken for removing the CO₂ from the gas stream is about 3 to 10 times an amount of time taken for removing the sorbed CO₂.

22. The method of claim 21, wherein the honeycomb monolith has a channel opening density of about 50 channels per square inch to 400 channels per square inch;
wherein the open face area (OFA) of the opposed surfaces is about 0.5 to 0.9; and
wherein a length of the honeycomb monolith is about 3 inches to 24 inches.

23. The method of claim 21, wherein the macropore and mesopore containing walls comprise mesopores and macropores;
wherein a macropore diameter is about 0.15 microns to 2 microns;
wherein a mesopore diameter is about 10 nm 50 nm;
wherein a mesopore volume is about 0.4 cc/g to 1.5 cc/g; and
wherein a ratio of macropores to mesopores is about 1:5 to about 2:1.

24. The method of claim 23, wherein the macropore and mesopore containing walls comprises sintered mesoporous particles having macropores separating the mesoporous particles, wherein the sorbent comprises an amine.

25. The method of claim 23, wherein the longitudinal channels comprise a solid macro-mesoporous coating that forms the macropore and mesopore containing walls.

26. The method of claim 25, wherein the macropore and mesopore containing walls is comprised of an inorganic oxide or a porous mineral/ceramic.

27. The method of claim 26, wherein the mesopores are physically impregnated with or chemically bonded to a sorbent comprising an amine.

28. The method of claim 25, wherein the amine is an aminopolymer, and wherein the aminopolymer is branched, hyperbranched, dendritic, or linear.

29. The method of claim 21, wherein the fraction is about 40% to 100%.

30. The method of claim 21, wherein the heating occurs by contacting the honeycomb monolith with steam.

31. The method of claim 31, wherein the gas stream has an approach velocity of about 2 m/s to 10 m/s.

32. The method of claim 31, wherein the gas stream comprises a CO₂ concentration of about 10% or less, and wherein the gas is selected from ambient air, flue gas, or a combination thereof.

33. The method of claim 31, wherein the amount of time taken for removing the CO₂ from the gas stream is about 3 times the amount of time taken for removing the sorbed CO₂, about 9 times the amount of time taken for removing the sorbed CO₂, or about 10 times the amount of time taken for removing the sorbed CO₂.

34. A system for removing CO₂ from a gas stream, the system comprising:
a loop of capture structures, each capture structure comprised of a honeycomb monolith, wherein the honeycomb monolith contains a CO₂ sorbent; and
wherein the number of capture structures is equal to a ratio, wherein the ratio is an amount of time taken for removing the CO₂ from the gas stream and an amount of time taken for removing the sorbed CO₂.

35. The system of claim 34, wherein the gas stream comprises a CO₂ concentration of about 10% or less, and wherein the gas is selected from ambient air, flue gas, or a combination thereof.

36. The system of claim 34, wherein the honeycomb monolith is comprised of longitudinal channels connecting two opposed surfaces of the monolith;
wherein the channels comprise macropore and mesopore containing walls; and
wherein the CO₂ sorbent occupies about 40% to 100% of a mesopore volume within the macropore and mesopore containing walls.

37. The system of claim 34, wherein the honeycomb monolith has a channel opening density of about 50 channels per square inch to 400 channels per square inch; wherein the open face area (OFA) of the opposed surfaces is about 0.5 to 0.9; and wherein a length of the honeycomb monolith is about 3 inches to 24 inches.

38. The system of claim 36, wherein the macropore and mesopore containing walls comprise mesopores and macropores; wherein a macropore diameter is about 0.15 microns to 2 microns; wherein a mesopore diameter is about 10 nm 50 nm; wherein a mesopore volume is about 0.4 cc/g to 1.5 cc/g; wherein a ratio of macropores to mesopores is about 1:5 to about 2:1.

39. The system of claim 36, wherein the macropore and mesopore containing walls comprises sintered mesoporous particles having macropores separating the mesoporous particles, wherein the sorbent comprises an amine.

40. The system of claim 33, wherein the macropore and mesopore containing walls is comprised of an inorganic oxide or a porous mineral/ceramic; and wherein the mesopores are physically impregnated with or chemically bonded to a sorbent comprising an amine.
